(19) United States
(12) Patent Application Publication
(10) Pub. No.: US 2025/0301043 A1
(43) Pub. Date: Sep. 25, 2025

(54) ELECTRONIC DEVICE FOR TRANSMITTING AND RECEIVING DATA TO AND FROM USER OF METAVERSE ON BASIS OF CALL APPLICATION, AND OPERATING METHOD THEREOF

(71) Applicant: Samsung Electronics Co., Ltd., Suwon-si (KR)

(72) Inventors: Sooyoung NAM, Suwon-si (KR); Yongsuk KWON, Suwon-si (KR); Youngjun SEO, Suwon-si (KR); Munhwan CHOI, Suwon-si (KR); Sunmin HWANG, Suwon-si (KR)

(21) Appl. No.: 19/229,565

(22) Filed: Jun. 5, 2025

Related U.S. Application Data
(63) Continuation of application No. PCT/KR2023/021403, filed on Dec. 22, 2023.

(30) Foreign Application Priority Data
Dec. 23, 2022 (KR) 10-2022-0182879
Jan. 3, 2023 (KR) 10-2023-0000609

(51) Int. Cl. H04L 67/133; G06T 19/00; H04L 9/40

(52) U.S. Cl. CPC H04L 67/133; G06T 19/003; H04L 63/08

(57) ABSTRACT

An electronic device is provided. The electronic device includes communication circuitry, memory, comprising one or more storage media, storing instructions, and one or more processors communicatively coupled to the communication circuitry and the memory, wherein the instructions, when executed by the one or more processors individually or collectively, cause the electronic device to receive, via the communication circuitry from at least one external electronic device, an identifier and log-in information about the at least one external electronic device, based on the identifier and the log-in information, obtain a virtual space list and a position list, the virtual space list including information associated with at least one virtual space, the position list including information associated with at least one position in the at least one virtual space, generate an application including the virtual space list and the location list, and transmit, via the communication circuitry to the at least one external electronic device, the application.

### CROSS-REFERENCE TO RELATED APPLICATION(S)

This application is a continuation application, claiming priority under 35 U.S.C. § 365(c), of an International application No. PCT/KR2023/021403, filed on Dec. 22, 2023, which is based on and claims the benefit of a Korean patent application number 10-2022-0182879, filed on Dec. 23, 2022, in the Korean Intellectual Property Office, and of a Korean patent application number 10-2023-0000609, filed on Jan. 3, 2023, in the Korean Intellectual Property Office, the disclosure of each of which is incorporated by reference herein in its entirety.

### BACKGROUND

### 1. Field

The disclosure relates to an electronic device transmitting/receiving data with a metaverse user based on a call application and an operating method thereof.

### 2. Description of Related Art

As wireless communication systems advance, the wireless communication system may provide internet protocol (IP)-based multimedia services (e.g., voice, video, and data) to the electronic device. For example, an electronic device may receive voice, video, or other media services via an IP multimedia subsystem (IMS) server.

Metaverse-related content is being actively provided. For example, virtual space-based metaverse-related content that performs a designated activity in a virtual space via an avatar may be provided. For example, there may be provided augmented reality-based metaverse-related content that allows additional information to be viewed as superposed on the actual environment or allows other objects to be viewed as superposed on the actual environment. As the metaverse-related content is advanced, a large number of users may access the metaverse service.

Users connected to the metaverse service may conduct a conversation based on chatting or voice chatting provided in the metaverse service or, as the avatars of a plurality of users are located in the virtual space, they may conduct a conversation in an environment, such as video chatting.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device transmitting/receiving data with a metaverse user based on a call application and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory, comprising one or more storage media, storing instructions, one or more processors communicatively coupled to the communication circuitry and the memory, wherein the instructions, when executed by the one or more processors individually or collectively, cause the electronic device to receive, via the communication circuitry from at least one external electronic device, an identifier and log-in information about the at least one external electronic device, based on the identifier and the log-in information, obtain a virtual space list and a position list, the virtual space list including information associated with at least one virtual space, the position list including information associated with at least one position in the at least one virtual space generate an application including the virtual space list and the position list, and transmit, via the communication circuitry to the at least one external electronic device, the application.

In accordance with another aspect of the disclosure, an electronic device is provided. The electronic device includes memory, comprising one or more storage media, storing instructions, communication circuitry, a display, and one or more processors communicatively coupled to the memory, the communication circuitry, and the display, wherein the instructions, when executed by the one or more processors individually or collectively, cause the electronic device to establish, via the communication circuitry, a call with an external electronic device, connect communication with the external electronic device by executing an application received from a first server, based on executing the application, select a second server corresponding to information associated with at least one virtual space among one or more virtual spaces included in a virtual space list, and transmit, via the communication circuitry to the external electronic device, selection information of the second server.

In accordance with another aspect of the disclosure, a method performed by an electronic device is provided. The method includes receiving, from at least one external electronic device, identification information about the at least one external electronic device, based on the identification information, obtaining a virtual space list and a position list, the virtual space list including information associated with at least one virtual space, the position list including information associated with at least one position in the at least one virtual space, generating an application including the virtual space list and the position list, and transmitting, to the at least one external electronic device, the application.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from at least one external electronic device, identification information about the at least one external electronic device, based on the identification information, obtaining a virtual space list and a position list, the virtual space list including information associated with at least one virtual space, the position list including information associated with at least one position in the at least one virtual space, generating an application including the virtual space list and the position list, and transmitting, to the at least one external electronic device, the application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating an internal configuration of a wearable electronic device according to an embodiment of the disclosure;

FIGS. 3A and 3B are views illustrating front and rear surfaces of a wearable electronic device according to various embodiments of the disclosure;

FIG. 4 is a block diagram illustrating an example configuration of an electronic device according to an embodiment of the disclosure;

FIG. 5 is a flowchart illustrating an operating method of an electronic device according to an embodiment of the disclosure;

FIG. 6 is a flowchart illustrating an operation of receiving a request for receiving an application of an electronic device according to an embodiment of the disclosure;

FIG. 7 is a view illustrating an example of obtaining information from a first server by an electronic device according to an embodiment of the disclosure;

FIG. 8 is a flowchart illustrating an example of an operation of transmitting an application by an electronic device according to an embodiment of the disclosure;

FIGS. 9A, 9B, and 9C are views illustrating an example of displaying an execution screen of an application by an electronic device according to various embodiments of the disclosure;

FIG. 10 is a flowchart illustrating an operation of selecting a server corresponding to information associated with a virtual space based on an application by an electronic device according to an embodiment of the disclosure;

FIGS. 11A, 11B, and 11C are views illustrating an example of selecting a server corresponding to information associated with a virtual space by an electronic device according to various embodiments of the disclosure;

FIG. 12 is a flowchart illustrating an operation of generating a virtual space list by an electronic device according to an embodiment of the disclosure;

FIG. 13 is a flowchart illustrating an operation of accessing a server corresponding to information associated with a virtual space by an electronic device according to an embodiment of the disclosure;

FIGS. 14A, 14B, and 14C are views illustrating an example of accessing a virtual space by an electronic device according to various embodiments of the disclosure;

FIG. 15 is a flowchart illustrating an operation of generating an application by an electronic device according to an embodiment of the disclosure;

FIG. 16 is a view illustrating an example of displaying an execution screen of an application by an electronic device according to an embodiment of the disclosure; and

FIG. 17 is a flowchart illustrating an operation of generating an application by an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

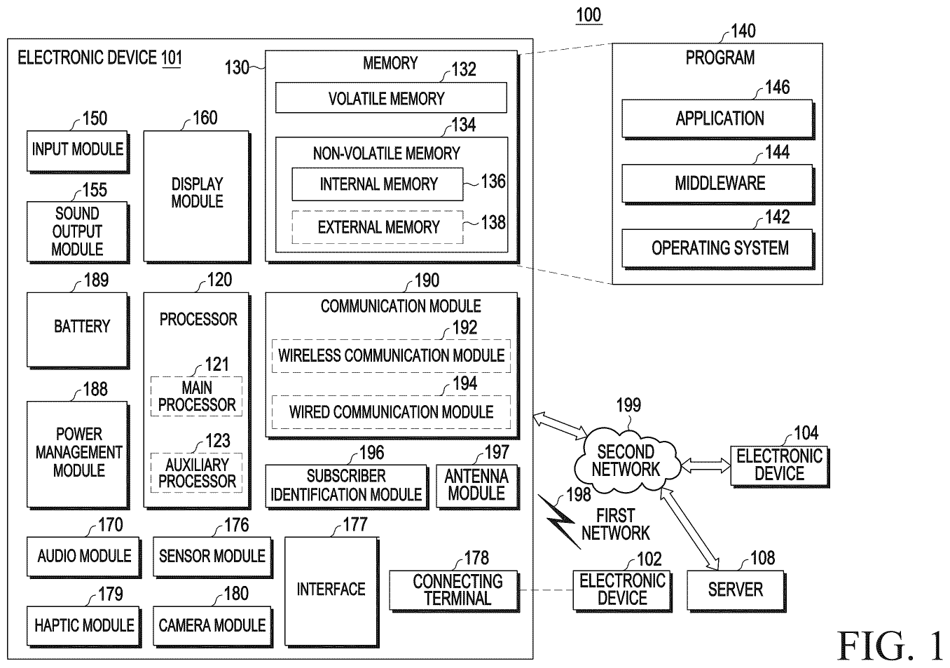

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™ wireless-fidelity (Wi-Fi™) direct, or infrared data association (IrDA)) or the second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices (e.g., the electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

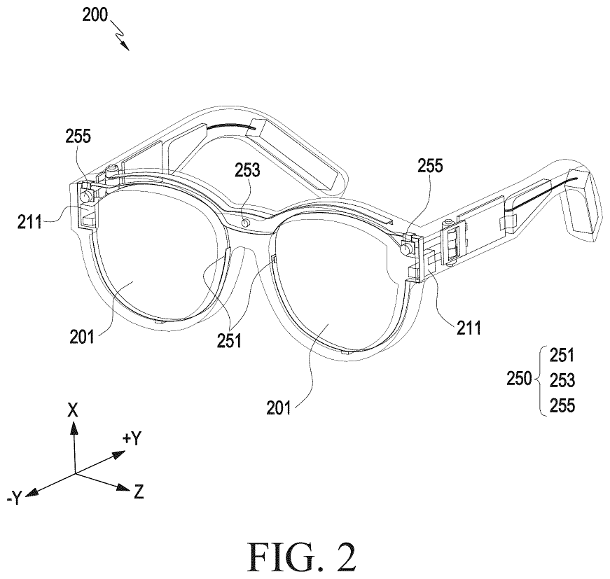

FIG. 2 is a perspective view illustrating an internal configuration of a wearable electronic device according to an embodiment of the disclosure.

Referring to FIG. 2, according to an embodiment of the disclosure, a wearable electronic device 200 may include at least one of a light output module 211, a display member 201, and a camera module 250.

According to an embodiment of the disclosure, the light output module 211 may include a light source capable of outputting an image and a lens guiding the image to the display member 201. According to an embodiment of the disclosure, the light output module 211 may include at least one of a liquid crystal display (LCD), a digital mirror device (DMD), a liquid crystal on silicon (LCoS), an organic light emitting diode (OLED), or a micro light emitting diode (micro LED).

According to an embodiment of the disclosure, the display member 201 may include an optical waveguide (e.g., a waveguide). According to an embodiment of the disclosure, the image output from the light output module 211 incident on one end of the optical waveguide may propagate inside the optical waveguide and be provided to the user. According to an embodiment of the disclosure, the optical waveguide may include at least one of at least one diffractive element (e.g., a diffractive optical element (DOE) or a holographic optical element (HOE)) or a reflective element (e.g., a reflective mirror). For example, the optical waveguide may guide the image output from the light output module 211 to the user's eyes using at least one diffractive element or reflective element.

According to an embodiment of the disclosure, the camera module 250 may capture still images and/or moving images. According to an embodiment, the camera module 250 may be disposed in a lens frame and may be disposed around the display member 201.

According to an embodiment of the disclosure, a first camera module 251 may capture and/or recognize the trajectory of the user's eye (e.g., pupil or iris) or gaze. According to an embodiment of the disclosure, the first camera module 251 may periodically or aperiodically transmit information related to the trajectory of the user's eye or gaze (e.g., trajectory information) to a processor (e.g., the processor 120 of FIG. 1).

According to an embodiment of the disclosure, a second camera module 253 may capture an external image.

According to an embodiment of the disclosure, a third camera module 255 may be used for hand detection and tracking, and recognition of the user's gesture (e.g., hand motion). According to an embodiment of the disclosure, the third camera module 255 may be used for 3 degrees of freedom (3DoF) or 6DoF head tracking, location (space, environment) recognition and/or movement recognition. The second camera module 253 may also be used for hand detection and tracking and recognition of the user's gesture. According to an embodiment of the disclosure, at least one of the first camera module 251 to the third camera module 255 may be replaced with a sensor module (e.g., a light detection and ranging (LiDAR) sensor). For example, the sensor module may include at least one of a vertical cavity surface emitting laser (VCSEL), an infrared sensor, and/or a photodiode.

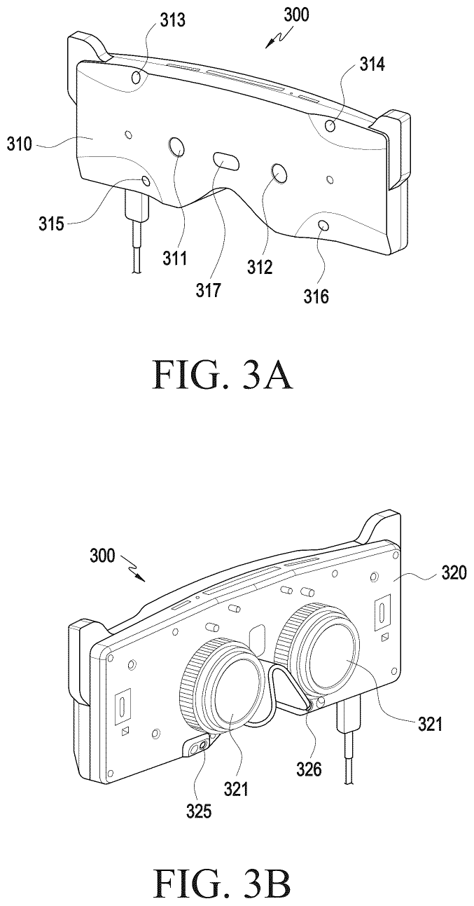

FIGS. 3A and 3B are views illustrating front and rear surfaces of a wearable electronic device according to various embodiments of the disclosure.

Referring to FIGS. 3A and 3B, in an embodiment, camera modules 311, 312, 313, 314, 315, and 316 and/or a depth sensor 317 for obtaining information related to the ambient environment of a wearable electronic device 300 may be disposed on a first surface 310 of the housing.

In an embodiment, the camera modules 311 and 312 may obtain images related to the ambient environment of the wearable electronic device.

In an embodiment, the camera modules 313, 314, 315, and 316 may obtain images while the wearable electronic device is worn by the user. The camera modules 313, 314, 315, and 316 may be used for hand detection, tracking, and recognition of the user gesture (e.g., hand motion). The camera modules 313, 314, 315, and 316 may be used for 3DoF or 6DoF head tracking, location (space or environment) recognition, and/or movement recognition. In an embodiment, the camera modules 311 and 312 may be used for hand detection and tracking and recognition of the user's gesture.

In an embodiment, the depth sensor 317 may be configured to transmit a signal and receive a signal reflected from an object and be used for identifying the distance to the object, such as time of flight (TOF). Alternatively or additionally to the depth sensor 217, the camera modules 213, 214, 215, and 216 may identify the distance to the object.

According to an embodiment, camera modules 325 and 326 for face recognition and/or a display 321 (and/or lens) may be disposed on a second surface 320 of the housing.

In an embodiment, the face recognition camera modules 325 and 326 adjacent to the display may be used for recognizing the user's face or may recognize and/or track both eyes of the user.

In an embodiment, the display 321 (and/or lens) may be disposed on the second surface 320 of the wearable electronic device 300. In an embodiment, the wearable electronic device 300 may not include the camera modules 315 and 316 among the plurality of camera modules 313, 314, 315, and 316. Although not shown in FIGS. 3A and 3B, the wearable electronic device 300 may further include at least one of the components shown in FIG. 2.

As described above, according to an embodiment, the wearable electronic device 300 may have a form factor to be worn on the user's head. The wearable electronic device 300 may further include a strap and/or a wearing member to be fixed on the user's body part. The wearable electronic device 300 may provide the user experience based on augmented reality, virtual reality, and/or mixed reality while worn on the user's head.

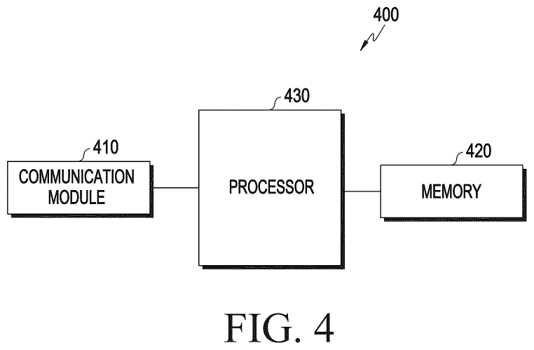

FIG. 4 is a block diagram illustrating an example of a configuration of an electronic device (e.g., the server 108 of FIG. 1) according to an embodiment of the disclosure.

Referring to FIG. 4, in an embodiment, an electronic device 400 may include a communication module 410, memory 420, and at least one processor 430 operatively connected to the communication module 410 and the memory 130.

In an embodiment, the communication module 410 may communicate with an external electronic device (e.g., the electronic device 101 of FIG. 1) via a second network (e.g., the second network 199 of FIG. 1). In an embodiment, the external electronic device performs an operation based on an application, such as a smartphone, a tablet PC, a laptop, a smart TV, or a desktop, and may be an electronic device including a voice input module (e.g., the input module 150 of FIG. 1), an audio output module (e.g., the sound output module 155 of FIG. 1), a display module (e.g., the display module 160 of FIG. 1), a camera module (e.g., the camera module 180 of FIG. 1) and/or a communication module 190. In an embodiment, the external electronic device may access a metaverse environment based on interworking with a wearable electronic device (e.g., the wearable electronic device 200 of FIG. 2 or the wearable electronic device 300 of FIGS. 3A and 3B). In an embodiment, when the wearable electronic device includes a communication module, the wearable electronic device may establish communication with the electronic device 400 without interworking with an electronic device such as a smartphone. In an embodiment, the external electronic device may support a voice call function (e.g., voice over long term evolution (VoLTE) or voice over new radio (VoNR)) to establish a call with another external electronic device. In an embodiment, the electronic device 400 (e.g., the communication module 410) may transmit data to an external electronic device and/or receive data from the external electronic device. In an embodiment, the electronic device 400 may transmit/receive data with one or more servers.

In an embodiment, the memory 420 may store an application (e.g., a web application in the form of a webpage) including at least one function. In an embodiment, the at least one function may include at least one of a function of selecting any one of one or more metaverse servers or a function of selecting any one position among one or more positions corresponding to the metaverse server. In an embodiment, the memory 420 may include (or store) a database DB including the application. The memory 420 may store instructions. The instructions may, when executed by the at least one processor 430, cause the electronic device 101 to perform at least one operation. A detailed operation performed by the electronic device 101 is described below. The processor performs the operation” may include “enabling the electronic device to perform the operation when the memory is executed by the processor.”

In an embodiment, the at least one processor 430 may generate an application including a function related to the selection of a metaverse server and perform an overall operation for transmitting the generated application to an external electronic device. In an embodiment, the at least one processor 430 may include one or more processors for generating and transmitting the application. One or more processors may be operatively connected to the communication module 410 and the memory 420. In an embodiment, the at least one processor 430 may generate an application to be transmitted to the external electronic device by loading the logic related to the application onto the memory 420 based on information received from the external electronic device via the communication module 410.

In an embodiment, the electronic device 400 may be referred to as an application server (AS). In an embodiment, the electronic device 400 may be implemented as an IP multimedia subsystem (IMS) data channel server, but is not limited thereto. Although FIG. 4 illustrates that the electronic device 400 includes a communication module 410, memory 420, and/or at least one processor 430, it is not limited thereto, and at least one component may be further included.

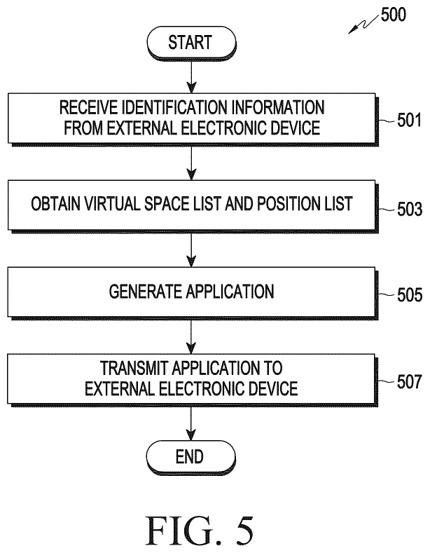

FIG. 5 is a flowchart describing a method for operating an electronic device (e.g., the server 108 of FIG. 1 or the electronic device 400 of FIG. 4) according to an embodiment of the disclosure.

In an embodiment, the operations shown in FIG. 5 are not limited to the shown order but may rather be performed in other various orders. For example, the order of each operation may be changed, and at least two operations may be performed in parallel. According to an embodiment, more or less operations than those of FIG. 5 may be performed.

Referring to FIG. 5, flowchart 500 illustrates that, in operation 501, in an embodiment, an electronic device 400 (e.g., the at least one processor 430 of FIG. 4) may receive identification information from an external electronic device.

In an embodiment, the electronic device 400 may obtain (or receive) identification information about at least one external electronic device from at least one external electronic device (e.g., the electronic device 101 of FIG. 1, the wearable electronic device 200 of FIG. 2, or the wearable electronic device 300 of FIGS. 3A and 3B) via the second network (e.g., the second network 199 of FIG. 1). In an embodiment, the identification information may include the user identifier (user ID) of at least one external electronic device. For example, the user identifier may include at least one of an ID, a phone number, a nickname, or an email address, but is not limited thereto. In an embodiment of the disclosure, the “virtual space” may include one or more spaces provided by the same metaverse server. In an embodiment, the “virtual spaces” may mean one or more virtual spaces provided by one or more metaverse servers, respectively.

In an embodiment, the electronic device 400 may receive identification information from one or more external electronic devices that have established a call therebetween. In an embodiment, the one or more external electronic devices may include a first external electronic device and a second external electronic device that establish a call therebetween. For example, the first and second external electronic devices may establish a call by transmitting/receiving request and response messages based on a protocol (e.g., a session initiation protocol (SIP) or a session description protocol (SDP)) for establishing a call. In an embodiment, the first external electronic device and the second external electronic device may establish a call via an IMS server based on VOLTE or VoNR. In an embodiment, the electronic device 400 may receive a request for an application regarding selection of a virtual space and/or a position in the virtual space from each of the first external electronic device and the second external electronic device while the call established between the first external electronic device and the second external electronic device is maintained. In an embodiment, the electronic device 400 may receive identification information corresponding to the first external electronic device and identification information corresponding to the second external electronic device from the first external electronic device and the second external electronic device, respectively, together with the request for the application. A specific operation of receiving the request for the application is described below.

In operation 503, in an embodiment, the electronic device 400 may obtain a virtual space list and a position list.

In an embodiment, the electronic device 400 may obtain, based on the identification information, a virtual space list including information associated with at least one virtual space and a position list including information associated with at least one position in the at least one virtual space. For example, the information associated with the virtual space may include at least one of an identifier (ID), an icon, a thumbnail, or a name of the virtual space. The information associated with the virtual space is not limited to the above-described example. For example, information associated with the position in the virtual space may include at least one of the identifier (ID), the icon, the trademark, or the position name that allows entry to a specific position in the virtual space. Information associated with the position of entry into the virtual space is not limited to the above-described examples. In an embodiment, the electronic device 400 may obtain information about the subscription of the external electronic device to at least one second server and information about log into the at least one second server based on communication with the first server. In an embodiment, the electronic device 400 may transmit (e.g., sendRequest) a request for subscription information and log-in information about at least one external electronic device to the first server via a communication module (e.g., the communication module 410 of FIG. 4). In an embodiment, the electronic device 400 may transmit identification information corresponding to at least one external electronic device to the first server. In an embodiment, the electronic device 400 may receive, from the first server, a response (e.g., sendResponse) generated by the first server based on the request. In an embodiment, the response may include subscription information and log-in information about at least one external electronic device. In an embodiment, the first server may be a server that stores account information corresponding to at least one external electronic device. For example, the account information may include subscription information about whether the at least one external electronic device (or the user of the external electronic device) subscribes to the at least one second server. In an embodiment, the subscription information may be a list of at least one second server to which at least one external electronic device subscribes. The subscription information may be a list of data indicating whether the external electronic device has subscribed to each second server. In an embodiment, the electronic device 400 may identify at least one second server to which at least one external electronic device subscribes based on obtaining the subscription information. In an embodiment, the electronic device 400 may obtain the virtual space list based on the subscription information. The account information may further include log-in information regarding whether the at least one external electronic device is logged in the at least one second server. In an embodiment, the second server may be a metaverse server that manages the virtual space. In an embodiment, the second server is not limited to one metaverse server, and may mean one or more metaverse servers corresponding to each content provider (CP).

In an embodiment, the electronic device 400 may transmit a request for a position list to at least one second server based on the subscription information about the at least one external electronic device received from the first server. In an embodiment, the electronic device 400 may transmit the request for the position list to at least one second server corresponding to information associated with at least one virtual space included in the virtual space list via the communication module 410, based on the obtained virtual space list. For example, the electronic device 400 may transmit the request for the position list to a second server corresponding to the identifier based on the identifier of any one of the identifiers associated with one or more virtual spaces included in the virtual space list. The electronic device 400 may transmit the request for the position list to servers respectively corresponding to the identifiers associated with one or more virtual spaces. The type of information associated with the virtual space that the electronic device 400 refers to transmit the request for the position list to the second server is not limited to the above-described example. In an embodiment, the electronic device 400 may further transmit information indicating that the external electronic device is logged in to the second server in which the external electronic device is logged in based on the log-in information received from the first server. In an embodiment, the electronic device 400 may receive, via the communication module 410, a position list obtained by the at least one second server based on the request from at least one second server. In an embodiment, the position list may include address information about at least one position in the virtual space. In an embodiment, the address information may include an IP address or a uniform resource identifier (URI) corresponding to the at least one position, but is not limited thereto. For example, when the virtual space includes one or more positions corresponding to one or more places in the real world, the position list may include information associated with a specific position corresponding to a specific place in the real world. For example, the information associated with the position may include at least one of the identifier, icon, trademark, or position name that allows entry to the specific position in the virtual space, but is not limited thereto. In an embodiment, the position list may include information associated with a specific position preset by the second server when the external electronic device is logged in to a specific second server. For example, the information associated with the position may include at least one of the identifier, icon, trademark, or position name that allows entry to the specific position in the virtual space, but is not limited thereto. In an embodiment, the position preset by the second server may be the position in the virtual space last visited by the user of the external electronic device or the position in the virtual space corresponding to the user's current position, but is not limited thereto. In an embodiment, the external electronic device may access the specific position within the virtual space based on address information corresponding to the specific position.

In an embodiment, the electronic device 400 may obtain the virtual space list and the position list even without communication with the first server. In an embodiment, the electronic device 400 may store information about at least one second server capable of connecting communication with at least one external electronic device in advance. In an embodiment, the electronic device 400 may obtain (or generate) a virtual space list including information associated with at least one virtual space corresponding to the at least one second server. For example, the information associated with the virtual space may include, but is not limited to, at least one of the identifier, icon, thumbnail, or name of the virtual space service of the virtual space. In an embodiment, the electronic device 400 may transmit the request for the position list to at least one second server based on receiving a request for an application from at least one external electronic device via the communication module 410. The electronic device 400 may obtain (or receive) the position list obtained by the second server based on the request from at least one second server via the communication module 410.

In operation 505, in an embodiment, electronic device 400 may generate an application.

In an embodiment, the electronic device 400 may generate an application including the obtained virtual space list and the obtained position list. In an embodiment, the application may be an IMS data channel application in the form of a webpage, but is not limited thereto. In an embodiment, the electronic device 400 may generate an application so that the application includes subscription information about at least one external electronic device and log-in information about at least one external electronic device. In an embodiment, the subscription information may include information indicating whether the external electronic device has subscribed to the second server corresponding to the virtual space included in the virtual space list. In an embodiment, the log-in information may include information indicating whether the external electronic device is currently logged in to the second server corresponding to information associated with the virtual space included in the virtual space list. In an embodiment, the electronic device 400 may generate an application so that the application further includes information about a notification obtained from at least one second server. In an embodiment, the obtained notification information may include a notification related to commercial marketing provided by the at least one second server, but is not limited thereto.

In operation 507, in an embodiment, the electronic device 400 may transmit the application to the external electronic device.

In an embodiment, the electronic device 400 may transmit the generated application to at least one external electronic device via the communication module 410. In an embodiment, the electronic device 400 may transmit a response (e.g., hypertext transfer protocol (HTTP) OK) indicating that the application has been transmitted based on the request for the application received from at least one external electronic device (e.g., the first external electronic device and the second external electronic device) in operation 501. In an embodiment, at least one external electronic device may execute the application received from the electronic device 400. For example, the external electronic device may execute an IMS data channel application in the form of a webpage on WebView. The electronic device 400 may allow one or more external electronic devices receiving the application to access a specific position within a specific virtual space based on transmitting the application including the virtual space list and the position list to one or more external electronic devices that have established a call therebetween.

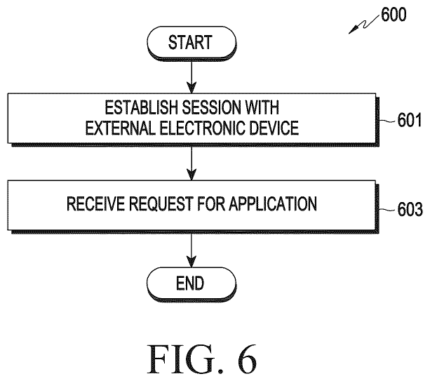

FIG. 6 is a flowchart illustrating an operation of receiving a request for an application of an electronic device (e.g., the electronic device 400 of FIG. 4) according to an embodiment of the disclosure.

In an embodiment, the operations shown in FIG. 6 are not limited to the shown order but may rather be performed in other various orders. For example, the order of each operation may be changed, and at least two operations may be performed in parallel. According to an embodiment, more or less operations than those of FIG. 6 may be performed.

Referring to FIG. 6, flowchart 600 illustrates that, in operation 601, in an embodiment, an electronic device 400 (e.g., the at least one processor 430 of FIG. 4) may establish a session with an external electronic device (e.g., the electronic device 101 of FIG. 1, the wearable electronic device 200 of FIG. 2, or the wearable electronic device 300 of FIGS. 3A and 3B).

In an embodiment, the electronic device 400 may establish a session for transmitting/receiving data with at least one external electronic device. In an embodiment, the electronic device 400 may establish a media session (e.g., an IMS data channel stream) with at least one external electronic device. In an embodiment, the electronic device 400 may establish a media session with one or more external electronic devices that have established a call therebetween. For example, the electronic device 400 may establish a media session with each of the first external electronic device and the second external electronic device that have established a call therebetween.

Referring to FIG. 6, in operation 603, in an embodiment, an electronic device 400 may receive a request for an application.

In an embodiment, the electronic device 400 may receive a request (e.g., GET HTTP) for an application (e.g., an IMS data channel application in the form of a webpage) from at least one external electronic device via the established session. In an embodiment, the electronic device 400 may receive a request for an application from one or more external electronic devices that have established a call therebetween. For example, the electronic device 400 may receive the request for the application from each of the first external electronic device and the second external electronic device that have established a call therebetween. In an embodiment, the electronic device 400 may obtain (or receive) identification information about at least one external electronic device via the second network (e.g., the second network 199 of FIG. 1). The identification information received by the electronic device 400 has been described, and no duplicate description may be given.

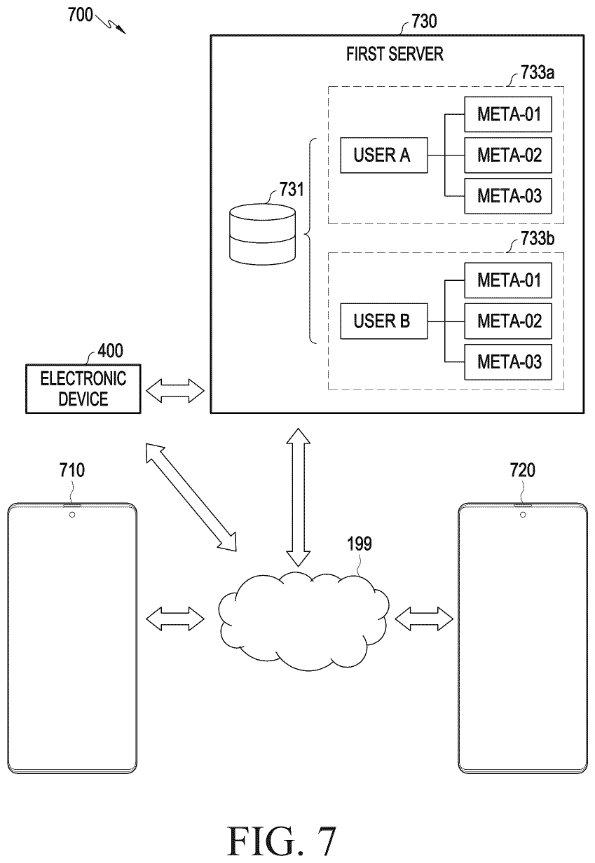

FIG. 7 is a diagram illustrating an example in which an electronic device (e.g., the server 108 of FIG. 1 or the electronic device 400 of FIG. 4) obtains information from a first server 730, according to an embodiment of the disclosure.

Referring to FIG. 7, in an embodiment, diagram 700 illustrates that an electronic device 400 may communicate with a first external electronic device 710 (e.g., the electronic device 101 of FIG. 1, the wearable electronic device 200 of FIG. 2, or the wearable electronic device 300 of FIGS. 3A and 3B), a second external electronic device 720 (e.g., the electronic device 101 of FIG. 1, the wearable electronic device 200 of FIG. 2, or the wearable electronic device 300 of FIGS. 3A and 3B) and/or a first server 730 via a second network 199 (e.g., the second network 199 of FIG. 1). In an embodiment, the electronic device 400 may transmit/receive data to/from the first server 730 via a communication network. In an embodiment, the first external electronic device 710 and/or the second external electronic device 720 may transmit the user identifier to the first server 730 based on subscribing to at least one metaverse server providing a metaverse service. In an embodiment, the user identifier may include at least one of the ID, the phone number, the nickname, or the email address, but is not limited thereto. In an embodiment, the first server 730 may store the user identifier corresponding to the first external electronic device 710 and/or the second external electronic device 720.

In an embodiment, the first external electronic device 710 and the second external electronic device 720 may establish a call via the second network 199. In an embodiment, the first external electronic device 710 and/or the second external electronic device 720 may transmit log-in information regarding whether it has currently accessed the at least one metaverse server to the first server 730 via the second network 199 based on accessing the at least one metaverse server. In an embodiment, the first server 730 may store information 733a about at least one metaverse server to which the first user (e.g., user A) has subscribed based on the user identifier corresponding to the first external electronic device 710. The first server 730 may store information 733b about at least one metaverse server to which the second user (e.g., user B) has subscribed based on the user identifier corresponding to the second external electronic device 720. In an embodiment, the electronic device 400 may transmit a request for subscription information and/or log-in information about the first external electronic device 710 and the second external electronic device 720 to the first server 730 based on receiving a request for an application from the first external electronic device 710 and the second external electronic device 720 that have established a call therebetween. In an embodiment, the electronic device 400 may receive, from the first server 730, subscription information and/or log-in information obtained by the first server 730 based on the request.

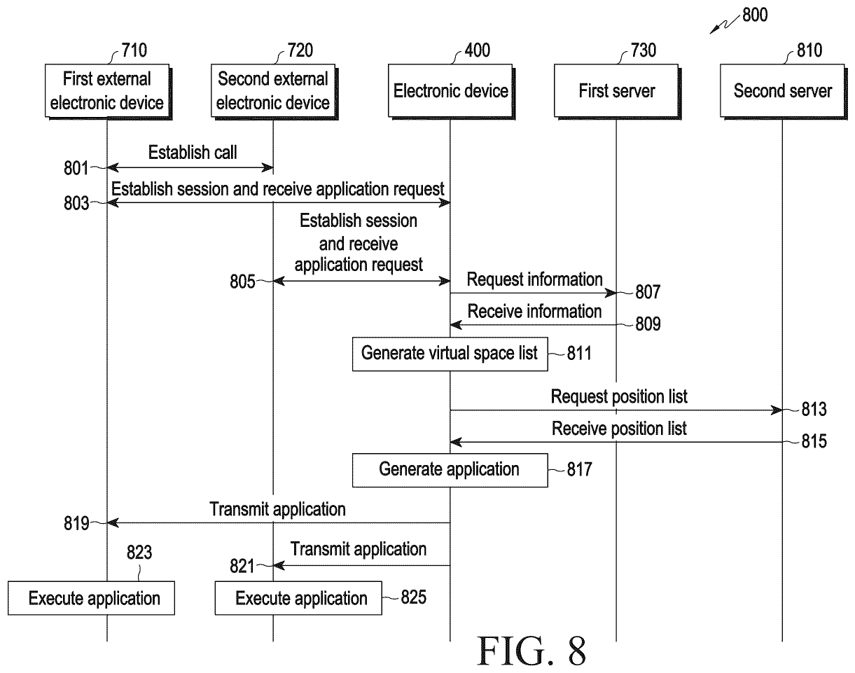

FIG. 8 is a flowchart illustrating an example of an operation in which an electronic device (e.g., the electronic device 400 of FIG. 4) transmits an application according to an embodiment of the disclosure.

In an embodiment, the operations shown in FIG. 8 are not limited to the shown order but may rather be performed in other various orders. For example, the order of each operation may be changed, and at least two operations may be performed in parallel. According to an embodiment, more or less operations than those of FIG. 8 may be performed. In an embodiment, in FIG. 8, the description overlapping FIG. 5 may not be repeated.

Referring to FIG. 8, according to an embodiment, flowchart 800 illustrates that, in operation 801, a first external electronic device 710 and a second external electronic device 720 may establish a call.

In operation 803, in an embodiment, an electronic device 400 may establish a session with the first external electronic device 710 and receive a request for an application from the first external electronic device 710. In an embodiment, the electronic device 400 may obtain (or receive) identification information about the first external electronic device 710 from the first external electronic device 710.

In operation 805, in an embodiment, the electronic device 400 may establish a session with the second external electronic device 720 and receive a request for an application from the second external electronic device 720. In an embodiment, the electronic device 400 may obtain (or receive) identification information about the second external electronic device 720 from the second external electronic device 720.

In operation 807, in an embodiment, the electronic device 400 may transmit a request for subscription information and/or log-in information about the first external electronic device 710 and the second external electronic device 720 to the first server 730.

In operation 809, in an embodiment, the electronic device 400 may receive, from the first server 730, subscription information and/or log-in information about the first external electronic device 710 and the second external electronic device 720.

In operation 811, in an embodiment, the electronic device 400 may generate a virtual space list based on the received subscription information and/or log-in information.

In operation 813, in an embodiment, the electronic device 400 may transmit the request for the position list to a second server 810. In an embodiment, the second server 810 is not limited to that shown in FIG. 8, and may include one or more metaverse servers.

In operation 815, in an embodiment, the electronic device 400 may receive a position list from the second server 810.

In operation 817, in an embodiment, the electronic device 400 may generate an application based on the virtual space list and the position list. In an embodiment, the electronic device 400 may generate an application including the virtual space list and the position list. The virtual space list may include information associated with the second server 810 to which the first external electronic device 710 and/or the second external electronic device 720 may connect. The position list may include information associated with at least one entry position in the virtual space provided by the second server 810.

In operation 819, in an embodiment, the electronic device 400 may transmit the generated application to the first external electronic device 710.

In operation 821, in an embodiment, the electronic device 400 may transmit the generated application to the second external electronic device 720.

In operation 823, in an embodiment, the first external electronic device 710 may execute the application received from the electronic device 400.

In operation 825, in an embodiment, the second external electronic device 720 may execute the application received from the electronic device 400. After operation 825, the first external electronic device 710 and the second external electronic device 720 may display a screen associated with a specific position in the virtual space provided by the second server 810 based on selecting identification information about the virtual space displayed on the execution screen of the application and/or identification information about the position in the virtual space.

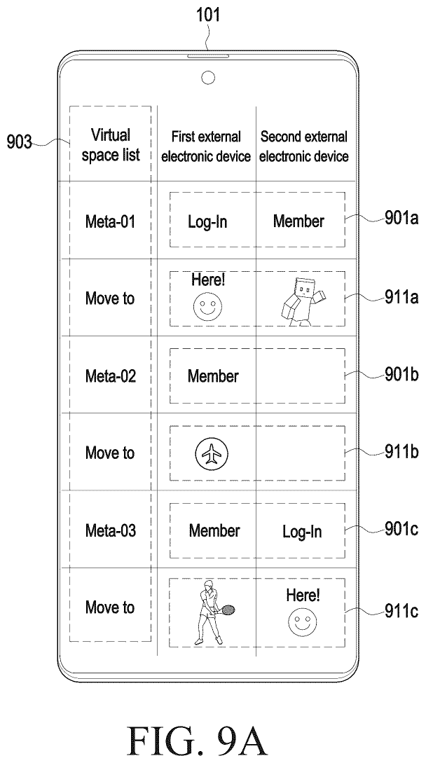

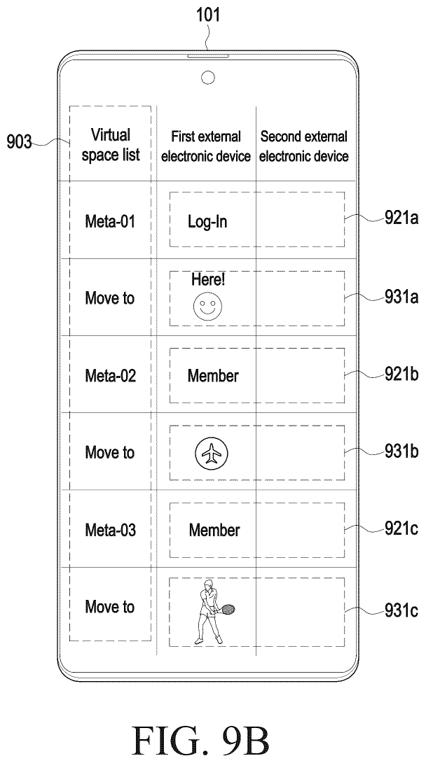

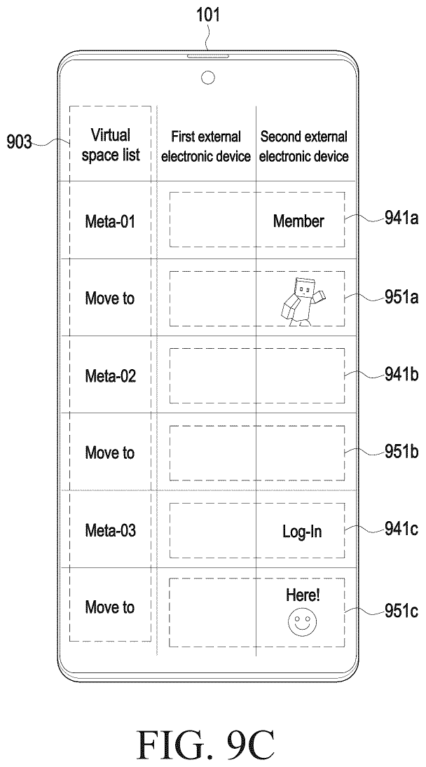

FIGS. 9A, 9B, and 9C are views illustrating an example in which an electronic device (e.g., the electronic device 101 of FIG. 1, the first external electronic device 710 of FIG. 7, or the second external electronic device 720 of FIG. 7) displays an execution screen of an application according to various embodiments of the disclosure.

Referring to FIG. 9A, in an embodiment, an electronic device 101 may display an execution screen of an application received from an electronic device 400. In an embodiment, the electronic device 101 may display a virtual space list 903 including log-in information about the first external electronic device (e.g., the first external electronic device 710 of FIG. 7) and the second external electronic device (e.g., the second external electronic device 720 of FIG. 7), and information associated with one or more virtual spaces. For example, the information associated with one or more virtual spaces may include, but is not limited to, at least one of the identifier, icon, thumbnail, or virtual space name that allows the virtual space to be identified. In an embodiment, the log-in information about the first external electronic device 710 and the second external electronic device 720 may include log-in information 901a about the first virtual space, log-in information 901b about the second virtual space, and log-in information 901c about the third virtual space. In an embodiment, referring to the log-in information 901a about the first virtual space, the electronic device 101 may display that the first external electronic device 710 is in a state of being logged in to the first metaverse server that manages the first virtual space. In an embodiment, referring to the log-in information 901a about the first virtual space, the electronic device 101 may display that the second external electronic device 720 is in a state of being not logged in to the first metaverse server that manages the first virtual space. In an embodiment, referring to the log-in information 901b about the second virtual space, the electronic device 101 may display that the first external electronic device 710 is in a state of being not logged in to the second metaverse server that manages the second virtual space. In an embodiment, referring to the log-in information 901b about the second virtual space, the electronic device 101 may display that the second external electronic device 720 has not subscribed to the second metaverse server. In an embodiment, referring to the log-in information 901c about the third virtual space, the electronic device 101 may display that the first external electronic device 710 is in a state of being not logged in to the third metaverse server that manages the third virtual space. In an embodiment, referring to the log-in information 901c about the third virtual space, the electronic device 101 may display that the second external electronic device 720 is in a state of being logged in to the third metaverse server. In an embodiment, the electronic device 101 may further include position lists 911a, 911b, and 911c including information associated with the position in each virtual space. For example, the information associated with the position in the virtual space may include at least one of the identifier, icon, trademark, or position name that allows entry to a specific position in the virtual space, but is not limited thereto. In an embodiment, the electronic device 101 may provide the position of the first external electronic device and/or the second external electronic device as a position in the virtual space corresponding to the metaverse server logged into by the first external electronic device and/or the second external electronic device.

Referring to FIG. 9B, an electronic device 101 may display subscription information 921a, 921b, and 921c about a first external electronic device 710 and/or a second external electronic device 720. The electronic device 101 may display position lists 931a, 931b, and 931c including information associated with the position in the virtual space for the first external electronic device 710 and/or the second external electronic device 720. In an embodiment, when the second external electronic device 720 does not provide identification information to the first server (e.g., the first server 730 of FIG. 7), the electronic device 101 may not display subscription information and the position list for the second external electronic device 720.

Referring to FIG. 9C, an electronic device 101 may display subscription information 941a, 941b, and 941c about a first external electronic device 710 and/or a second external electronic device 720. The electronic device 101 may display position lists 951a, 951b, and 951c including information associated with the position in the virtual space for the first external electronic device 710 and/or the second external electronic device 720. In an embodiment, when the first external electronic device 710 does not provide identification information to the first server (e.g., the first server 730 of FIG. 7), the electronic device 101 may not display subscription information and the position list for the first external electronic device 710.

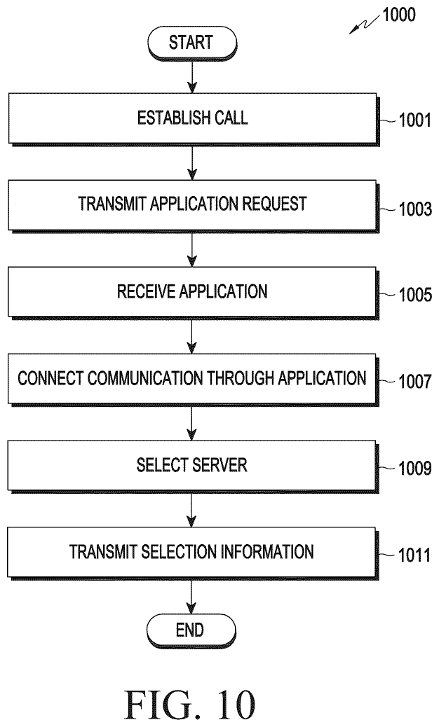

FIG. 10 is a flowchart illustrating an operation in which an electronic device (e.g., the electronic device 101 of FIG. 1, the first external electronic device 710 of FIG. 7, or the second external electronic device 720 of FIG. 7) selects a server (e.g., the second server 810 of FIG. 8) corresponding to information associated with a virtual space based on an application according to an embodiment of the disclosure.

In an embodiment, the operations shown in FIG. 10 are not limited to the shown order but may rather be performed in other various orders. For example, the order of each operation may be changed, and at least two operations may be performed in parallel. According to an embodiment, more or less operations than those of FIG. 10 may be performed. In an embodiment, in FIG. 10, the description overlapping FIG. 5 may not be repeated.

Referring to FIG. 10, in an embodiment, flowchart 1000 illustrates that, in operation 1001, an electronic device 101 (e.g., the processor 120 of FIG. 1) may establish a call. In an embodiment, the electronic device 101 may establish a call with an external electronic device (e.g., the first external electronic device 710 or the second external electronic device 720 of FIG. 7).

In operation 1003, in an embodiment, the electronic device 101 may transmit a request for an application. In an embodiment, the electronic device 101 may transmit a request for an application to the application server (e.g., the server 108 of FIG. 1 or the electronic device 400 of FIG. 4).

In operation 1005, in an embodiment, the electronic device 101 may receive the application. In an embodiment, the electronic device 101 may receive the application from the application server.

In operation 1007, in an embodiment, the electronic device 101 may connect communication via the application.

In an embodiment, the electronic device 101 may connect communication with an external electronic device by executing the application. In an embodiment, the external electronic device may be an electronic device that has established a call with the electronic device 101 in operation 1001. The external electronic device may transmit a request for an application to the application server and receive the application from the application server. The external electronic device may execute the received application. The electronic device 101 and the external electronic device may connect communication via the executed application.

In operation 1009, in an embodiment, the electronic device 101 may select a server (e.g., the second server 810 of FIG. 8) corresponding to information associated with the virtual space based on executing the application. In an embodiment, the electronic device 101 may select a server corresponding to information associated with any one of one or more virtual spaces included in the executed application based on obtaining a user input to at least a partial area of the application execution screen via a display module (e.g., the display module 160 of FIG. 1). In an embodiment, the user input may be a touch event on the display module 160, but is not limited thereto. The information associated with the virtual space may include at least one of the identifier, the icon, the thumbnail, or the name of the virtual space service, but is not limited thereto. For example, the electronic device 101 may select a server corresponding to the icon of the virtual space based on obtaining (or detecting) a user input to the icon of the virtual space displayed on the execution screen of the application. In an embodiment, the server corresponding to the icon of the virtual space may be a server operated by a content provider that manages the virtual space.

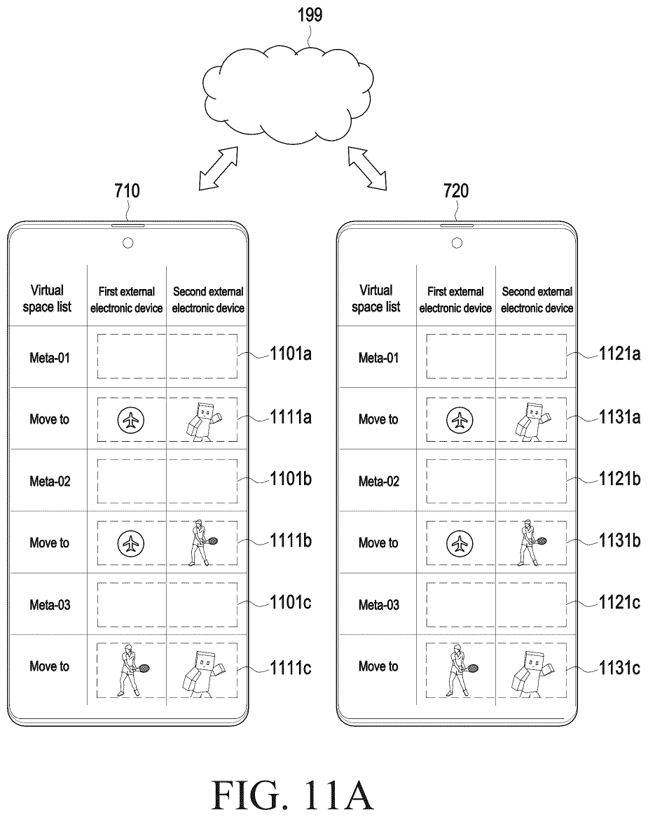

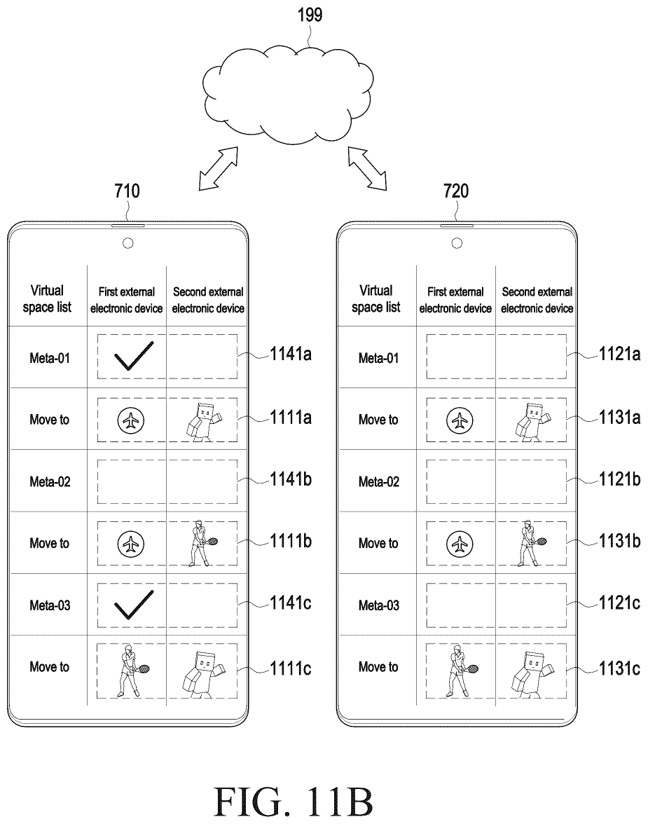

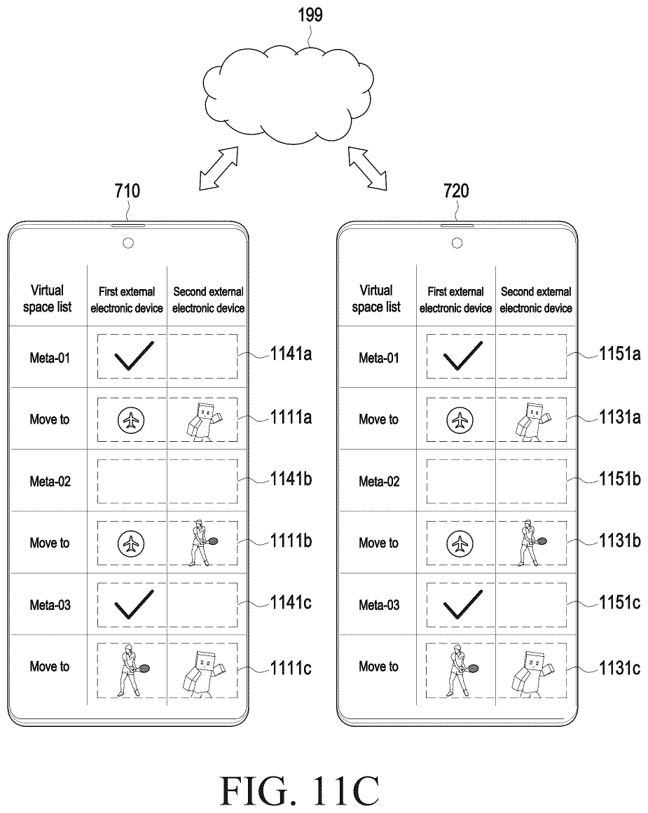

In operation 1011, in an embodiment, the electronic device 101 may transmit selection information of the server corresponding to the information associated with the virtual space. In an embodiment, the electronic device 101 may transmit selection information including identification information about the selected server to the external electronic device to which communication is connected via the second network (e.g., the second network 199 of FIG. 1). In an embodiment, the server identification information may include at least one of the address, the identifier, the icon, or the name of the server, but is not limited thereto. Selection of the server corresponding to information associated with the virtual space and transmission of the selection information of the server in operations 1009 and 1011 according to an embodiment are described below with reference to FIGS. 11A, 11B, and 11C.

FIGS. 11A, 11B, and 11C are views illustrating an example in which an electronic device (e.g., the electronic device 101 of FIG. 1, the first external electronic device 710 of FIG. 7, or the second external electronic device 720 of FIG. 7) selects a server (e.g., the second server 810 of FIG. 8) corresponding to information associated with a virtual space according to various embodiments of the disclosure.

Referring to FIG. 11A, in an embodiment, a first external electronic device 710 may display position lists 1111a, 1111b, and 1111c for each metaverse server (e.g., the second server 810 of FIG. 7) by executing an application received from the application server (e.g., the server 108 of FIG. 1 or the electronic device 400 of FIG. 4). When each of the first external electronic device 710 and the second external electronic device 720 does not provide subscription information to the first server (e.g., the first server 730 of FIG. 7), the first external electronic device 710 may not display subscription information 1101a, 1101b, and 1101c about each metaverse server. In an embodiment, the second external electronic device 720 may display position lists 1131a, 1131b, and 1131c for each metaverse server by executing the application received from the application server. When each of the first external electronic device 710 and the second external electronic device 720 does not provide subscription information to the first server 730, the second external electronic device 720 may not display subscription information 1121a, 1121b, and 1121c for each metaverse server.

Referring to FIG. 11B, in an embodiment, a first external electronic device 710 may select a server corresponding to information associated with at least one virtual space from among one or more virtual spaces based on at least one user input. In an embodiment, the user input may be a touch event for at least a partial area of the display module of the first external electronic device 710, but is not limited thereto. The information associated with the virtual space may include at least one of the identifier, the icon, the thumbnail, or the name of the virtual space service, but is not limited thereto. The first external electronic device 710 may display subscription information 1141a and 1141c about at least one metaverse server corresponding to information associated with the selected virtual space. In an embodiment, the first external electronic device 710 may not display subscription information 1141b about the metaverse server corresponding to information associated with an unselected virtual space.

Referring to FIG. 11C, in an embodiment, a first external electronic device 710 may transmit selection information including identification information about at least one selected server to the second external electronic device 720 via the second network 199 (e.g., the second network 199 of FIG. 1). In an embodiment, the server identification information may include at least one of the address, the identifier, the icon, or the name of the server, but is not limited thereto. In an embodiment, the second external electronic device 720 may display subscription information 1151a and 1151c about at least one metaverse server corresponding to information associated with the virtual space selected by the first external electronic device 710. In an embodiment, the second external electronic device 720 may not display the subscription information 1151b about the metaverse server corresponding to information associated with the virtual space not selected by the first external electronic device 710.

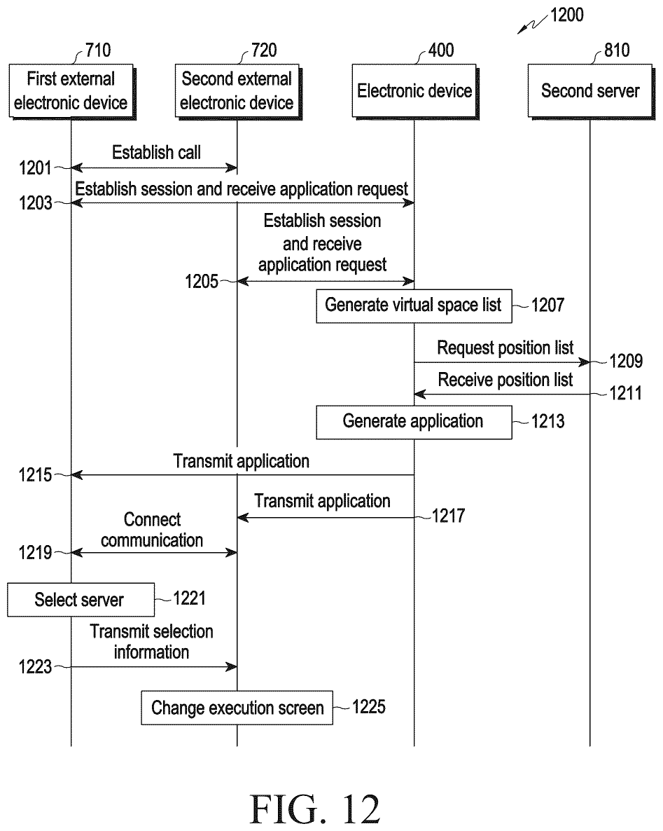

FIG. 12 is a flowchart illustrating an operation of generating a virtual space list by an electronic device (e.g., the server 108 of FIG. 1 or the electronic device 400 of FIG. 4) according to an embodiment of the disclosure.

In an embodiment, the operations shown in FIG. 12 are not limited to the shown order but may rather be performed in other various orders. For example, the order of each operation may be changed, and at least two operations may be performed in parallel. According to an embodiment, more or less operations than those of FIG. 12 may be performed. In an embodiment, in FIG. 12, the description overlapping FIGS. 8, 9A to 9C, 10, and 11A to 11C may not be repeated.

Referring to FIG. 12, in an embodiment, flowchart 1200 illustrates that, in operation 1201, a first external electronic device (e.g., the first external electronic device 710 of FIG. 7) and a second external electronic device (e.g., the second external electronic device 720 of FIG. 7) may establish a call.

In operation 1203, in an embodiment, an electronic device 400 may establish a session with the first external electronic device 710 and receive a request for an application from the first external electronic device 710. In an embodiment, the electronic device 400 may obtain (or receive) identification information about the first external electronic device 710 from the first external electronic device 710.

In operation 1205, in an embodiment, the electronic device 400 may establish a session with the second external electronic device 720 and receive a request for an application from the second external electronic device 720. In an embodiment, the electronic device 400 may obtain (or receive) identification information about the second external electronic device 720 from the second external electronic device 720.

In operation 1207, in an embodiment, the electronic device 400 may generate a virtual space list based on information about at least one second server (e.g., the second server 810 of FIG. 8) previously stored in the electronic device 400. The electronic device 400 may generate a virtual space list without communicating with the first server (e.g., the first server 730 of FIG. 8). In an embodiment, the virtual space list may include information associated with one or more virtual spaces. For example, information associated with virtual spaces may include at least one of the identifier, icon, thumbnail, or name of the virtual space service of each of the virtual spaces, and is not limited to the above-described examples. The virtual spaces may be managed by each of the metaverse servers corresponding to information associated with the virtual space.

In operation 1209, in an embodiment, the electronic device 400 may transmit the request for the position list to the second server 810. The electronic device 400 may transmit the request for the position list to the second server 810 corresponding to information associated with one or more virtual spaces included in the virtual space list based on the generated virtual space list. In an embodiment, the second server 810 is not limited to that shown in FIG. 12, and may include one or more metaverse servers.

In operation 1211, in an embodiment, the electronic device 400 may receive a position list from the second server 810. In an embodiment, the position list may include information associated with one or more positions in the virtual space. For example, the information associated with positions may include at least one of the identifier, icon, trademark, or position name that allows entry to the specific position in the virtual space, but is not limited thereto.

In operation 1213, in an embodiment, the electronic device 400 may generate an application based on the virtual space list and the position list.

In operation 1215, in an embodiment, the electronic device 400 may transmit the generated application to the first external electronic device 710.

In operation 1217, in an embodiment, the electronic device 400 may transmit the generated application to the second external electronic device 720.

In operation 1219, in an embodiment, the first external electronic device 710 may connect communication with the second external electronic device 720 by executing the application received from the electronic device 400.

In operation 1221, in an embodiment, the first external electronic device 710 may select a second server 810 corresponding to information associated with at least one virtual space from among one or more virtual spaces. The first external electronic device 710 may select at least one second server 810 that manages the virtual space based on a user input to at least a portion of the execution screen of the application. For example, the user input may be a touch event to the display module of the first external electronic device 710, but is not limited thereto.

In operation 1223, in an embodiment, the first external electronic device 710 may transmit selection information about the second server 810 to the second external electronic device 720. In an embodiment, the selection information about the second server 810 may include identification information about at least one selected metaverse server. For example, the identification information about the metaverse server may include at least one of the address, the identifier, the icon, or the name of the server, but is not limited thereto. The first external electronic device 710 may display an icon associated with the virtual space corresponding to the selected metaverse server on the execution screen of the application.

In operation 1225, in an embodiment, the second external electronic device 720 may change the execution screen of the application received from the electronic device 400 based on the selection information about the second server 810 received from the first external electronic device 710. In an embodiment, the second external electronic device 720 may display information associated with the virtual space corresponding to the selected at least one metaverse server on the execution screen of the application based on the selection information about the second server 810. For example, the second external electronic device 720 may display the icon of the virtual space corresponding to the metaverse server selected by the first external electronic device 710 on the execution screen of the application. Based on performing operation 1225, the second external electronic device 720 may change the execution screen of the application to display the same execution screen as the execution screen of the first external electronic device 710.

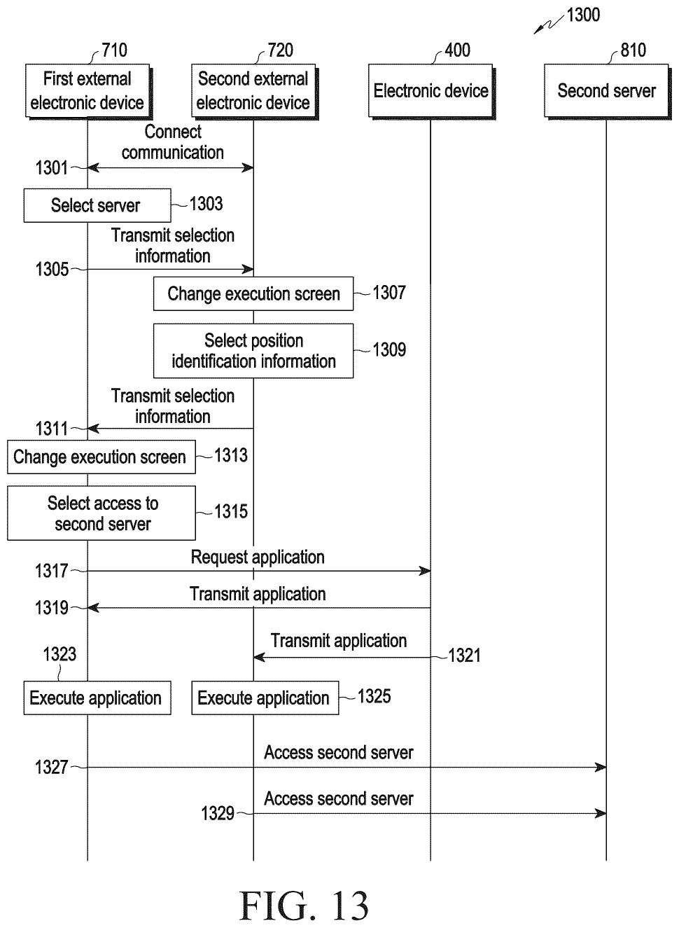

FIG. 13 is a flowchart illustrating an operation in which an electronic device (e.g., the electronic device 101 of FIG. 1, the first external electronic device 710 of FIG. 7, or the second external electronic device 720 of FIG. 7) accesses a second server corresponding to information associated with a virtual space according to an embodiment of the disclosure.

Referring to FIG. 13, in an embodiment, flowchart 1300 illustrates that, in operation 1301, a first external electronic device 710 may connect communication with a second external electronic device 720 by executing an application received from an electronic device 400. In an embodiment, operation 1301 may be identical or similar in whole or part to operation 1219 of FIG. 12.

In operation 1303, in an embodiment, the first external electronic device 710 may select the second server 810 corresponding to information associated with at least one virtual space from among one or more virtual spaces. In an embodiment, operation 1303 may be identical or similar in whole or part to operation 1221 of FIG. 12.

In operation 1305, in an embodiment, the first external electronic device 710 may transmit selection information about the second server 810 to the second external electronic device 720. In an embodiment, operation 1305 may be identical or similar in whole or part to operation 1223 of FIG. 12.

In operation 1307, in an embodiment, the second external electronic device 720 may change the execution screen of the application received from the electronic device 400 based on the selection information about the second server 810 received from the first external electronic device 710. In an embodiment, operation 1307 may be identical or similar in whole or part to operation 1225 of FIG. 12.

In operation 1309, in an embodiment, the second external electronic device 720 may select identification information about any one of one or more positions included in the position list. For example, the position identification information may include at least one of the identifier, icon, trademark, or position name that allows entry to the specific position in the virtual space provided by the second server 810, but is not limited thereto. The second external electronic device 720 may select identification information about the position in the virtual space provided by the second server 810 selected by the first external electronic device 710 based on a user input to at least a portion of the execution screen of the application.

In operation 1311, in an embodiment, the second external electronic device 720 may transmit position selection information to the first external electronic device 710. The position selection information may include identification information about the position selected by the second external electronic device 720. The second external electronic device 720 may change the identification information about the selected position on the execution screen of the application. For example, the second external electronic device 720 may further display an icon related to the selection of the identification information on the position identification information.

In operation 1313, in an embodiment, the first external electronic device 710 may change the execution screen of the application received from the electronic device 400 based on the position selection information received from the second external electronic device 720. The first external electronic device 710 may change the identification information about the position on the execution screen of the application based on the position selection information. For example, the first external electronic device 710 may further display an icon related to the selection of the identification information on the identification information about the position selected by the second external electronic device 720. The first external electronic device 710 may change the execution screen of the application to display the same execution screen as the execution screen of the second external electronic device 720 based on further displaying the icon related to selection of identification information.

In operation 1315, in an embodiment, the first external electronic device 710 may select access to the second server 810 corresponding to information associated with the virtual space. In an embodiment, the first external electronic device 710 may select access to the second server 810 corresponding to information associated with any one of the one or more virtual spaces included in the virtual space list. For example, the first external electronic device 710 may select access to the second server 810 selected based on operation 1303. The first external electronic device 710 may select access to the second server 810 based on the selection information received from the second external electronic device 720 based on operation 1311.

In operation 1317, in an embodiment, the first external electronic device 710 may transmit a request for an application to the electronic device 400. For example, the application request may include information associated with the second server 810 selected by the first external electronic device 710 and identification information about the position selected by the second external electronic device 720. In an embodiment, the electronic device 400 may generate an application including address information about the second server 810 corresponding to the virtual space requested to be accessed based on receiving a request for an application from the first external electronic device 710. In an embodiment, the address information may include an IP address or a URI, but is not limited thereto. The address information about the second server 810 may further include address information for entering a specific position in the virtual space provided by the second server 810 in relation to the identification information about the position selected by the second external electronic device 720.

In operation 1319, in an embodiment, the electronic device 400 may transmit the application to the first external electronic device 710. In operation 1321, in an embodiment, the electronic device 400 may transmit the application to the second external electronic device 720.

In operation 1323, in an embodiment, the first external electronic device 710 may execute the application received from the electronic device 400. In operation 1325, in an embodiment, the second external electronic device 720 may execute the application received from the electronic device 400.

In operation 1327, in an embodiment, the first external electronic device 710 may access the selected second server 810 based on executing the application received from the electronic device 400. In operation 1329, in an embodiment, the second external electronic device 720 may access the second server 810 selected by the first external electronic device 710 based on executing the application received from the electronic device 400. The first external electronic device 710 and the second external electronic device 720 may display a screen associated with a specific position in the virtual space provided by the second server 810. For example, the specific position in the virtual space may be associated with identification information about the position selected by the second external electronic device 720.

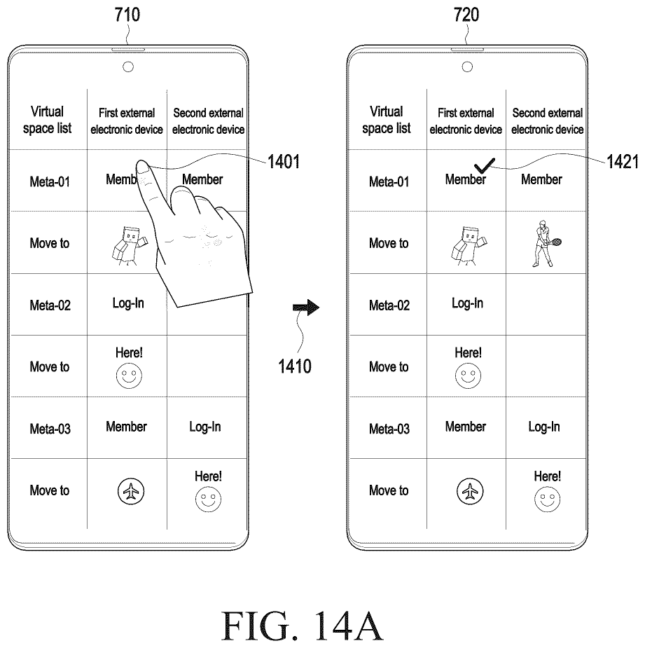

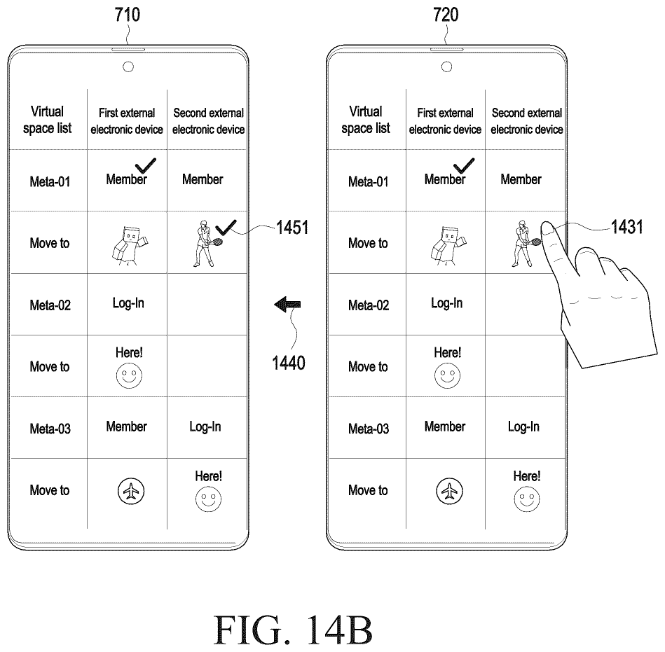

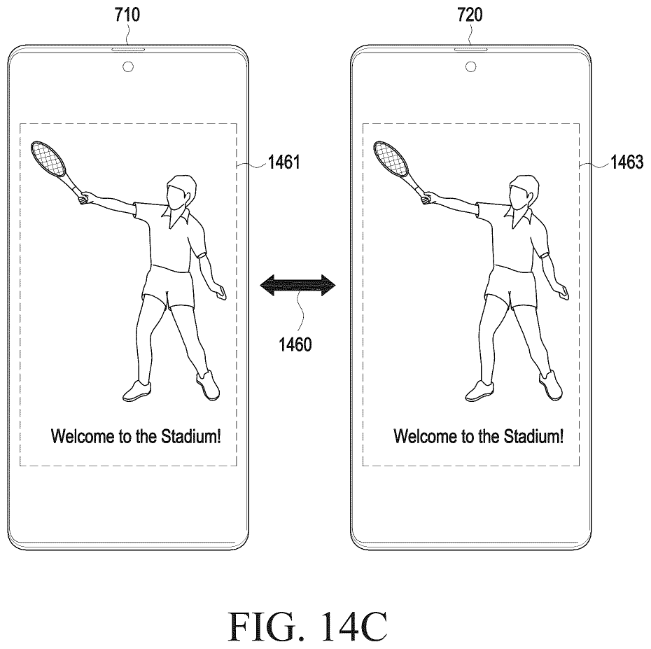

FIGS. 14A, 14B, and 14C are views illustrating an example in which an electronic device (e.g., the electronic device 101 of FIG. 1, the first external electronic device 710 of FIG. 7, or the second external electronic device 720 of FIG. 7) accesses a server (e.g., the second server 810 of FIG. 13) corresponding to information associated with a virtual space according to various embodiments of the disclosure.

In an embodiment, the first external electronic device 710 may connect communication with the second external electronic device 720 by executing the application received from the electronic device 400.

Referring to FIG. 14A, in an embodiment, a first external electronic device 710 may select a second server 810 corresponding to information associated with the virtual space based on a user input 1401 to information associated with at least one virtual space among one or more virtual spaces. In an embodiment, the user input may be a touch event to at least a partial area of the execution screen of the application, but is not limited thereto. The information associated with the virtual space may include at least one of the identifier, the icon, the thumbnail, or the name of the virtual space service provided by the second server 810, but is not limited thereto. For example, the first external electronic device 710 may select a first metaverse server corresponding to information (e.g., meta-01) associated with the virtual space based on the user input 1401. In an embodiment, the first external electronic device 710 may transmit, as indicated at arrow 1410, selection information about the second server 810 to a second external electronic device 720. The selection information about the second server 810 may include information (e.g., meta-01) associated with the virtual space provided by the second server 810 selected by the first external electronic device 710. In an embodiment, the second external electronic device 720 may change the execution screen of the application received from the electronic device 400 based on the selection information about the second server 810 received from the first external electronic device 710. For example, the second external electronic device 720 may display an icon 1421 indicating the selection of the first external electronic device 710 on the execution screen of the application based on the selection information about the second server 810.

Referring to FIG. 14B, in an embodiment, a second external electronic device 720 may select identification information about any one of one or more positions included in the position list based on a user input 1431 to at least a partial area of the execution screen of the application. For example, the position identification information may include at least one of the identifier, icon, trademark, or position name that allows entry to the specific position in the virtual space provided by the second server 810, but is not limited thereto. In an embodiment, the second external electronic device 720 may transmit, as indicated at arrow 1440, position selection information to the first external electronic device 710. The position selection information may include identification information about the position selected by the second external electronic device 720. In an embodiment, the first external electronic device 710 may change the execution screen of the application received from the electronic device 400 based on the position selection information received from the second external electronic device 720. The first external electronic device 710 may further display an icon 1451 associated with the selection of the identification information based on the identification information about the position selected by the second external electronic device 720.

Referring to FIG. 14C, in an embodiment, a first external electronic device 710 and a second external electronic device 720 may display execution screens 1461 and 1463 of the virtual space provided by a second server 810 by accessing the selected second server 810 based on performing communication, as indicated at arrow 1460. In an embodiment, the first external electronic device 710 may select access to the second server 810 corresponding to information (e.g., meta-01) associated with the virtual space of FIG. 14B and transmit a request for an application to the electronic device (e.g., the electronic device 400 of FIG. 13). For example, the application request may include information associated with the second server 810 selected by the first external electronic device 710 and identification information about the position selected by the second external electronic device 720. In an embodiment, the electronic device 400 may generate an application including address information about the second server 810 requested to be accessed based on receiving a request for an application from the first external electronic device 710. In an embodiment, the address information may include an IP address or a URI, but is not limited thereto. In an embodiment, the electronic device 400 may transmit the application to the first external electronic device 710. In an embodiment, the electronic device 400 may transmit the application to the second external electronic device 720. In an embodiment, the first external electronic device 710 may execute the application received from the electronic device 400. In an embodiment, the second external electronic device 720 may execute the application received from the electronic device 400. In an embodiment, the first external electronic device 710 may access the selected second server 810 based on executing the application received from the electronic device 400. In an embodiment, the second external electronic device 720 may access the second server 810 selected by the first external electronic device 710 based on executing the application received from the electronic device 400. The first external electronic device 710 and the second external electronic device 720 may display execution screens 1461 and 1463 associated with a specific position in the virtual space provided by the second server 810. The specific position in the virtual space may be associated with identification information about the position selected by the second external electronic device 720.

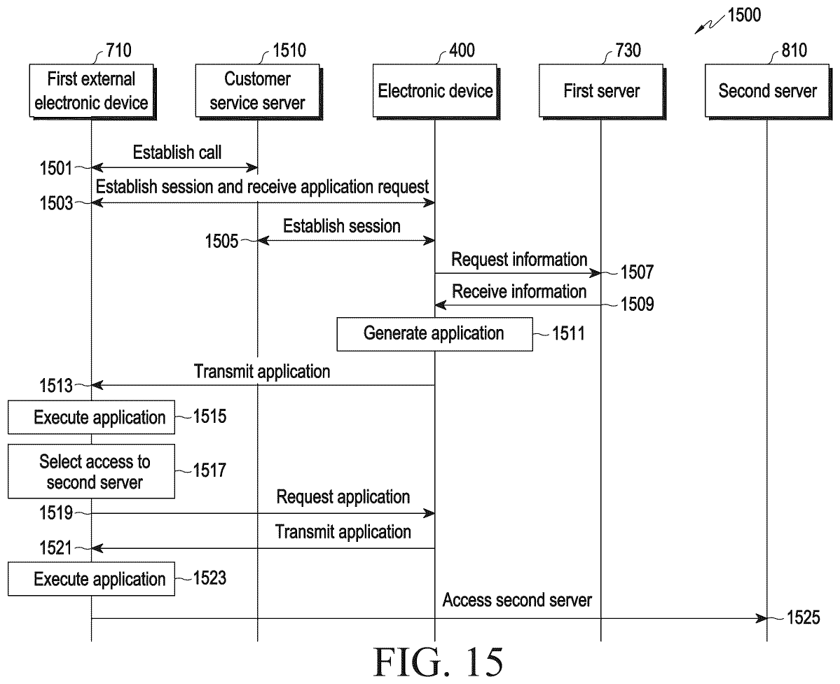

FIG. 15 is a flowchart illustrating an operation in which an electronic device (e.g., the server 108 of FIG. 1 or the electronic device 400 of FIG. 4) generates an application according to an embodiment of the disclosure.

In an embodiment, the operations shown in FIG. 15 are not limited to the shown order but may rather be performed in other various orders. For example, the order of each operation may be changed, and at least two operations may be performed in parallel. According to an embodiment, more or less operations than those of FIG. 15 may be performed. In an embodiment, in FIG. 15, the description overlapping FIGS. 5 to 8, 9A to 9C, 10, 11A to 11C, 12, 13, and 14A to 14C may not be repeated.

Referring to FIG. 15, in an embodiment, flowchart 1500 illustrates that, in operation 1501, a first external electronic device 710 may establish a call with a customer service server 1510. In an embodiment, the customer service server 1510 may be a server for guidance related to customer service. The customer service server 1510 may provide customer service in one or more virtual spaces via one or more second servers 810. Although FIG. 15 shows one second server 810, the second server 810 may be one or more servers that manage one or more virtual spaces, respectively.

In operation 1503, in an embodiment, an electronic device 400 may establish a session with the first external electronic device 710 and receive a request for an application from the first external electronic device 710. In an embodiment, the electronic device 400 may obtain identification information about the first external electronic device 710 from the first external electronic device 710.

In operation 1505, in an embodiment, the electronic device 400 may establish a session with the customer service server 1510.

In operation 1507, in an embodiment, the electronic device 400 may transmit a request for subscription information and/or log-in information about the first external electronic device 710 to the first server 730. The subscription information may include information associated with the second server 810 to which the first external electronic device 710 subscribes. The log-in information may include information about whether the first external electronic device 710 is logged in to the second server 810 to which it subscribes.

In operation 1509, in an embodiment, the electronic device 400 may receive, from the first server 730, subscription information and/or log-in information about the first external electronic device 710.

In operation 1511, in an embodiment, the electronic device 400 may generate an application including information associated with at least one virtual space where a customer service may be used, based on the received subscription information and/or log-in information. The information associated with the virtual space may be information that allows the second server 810 included in the subscription information to be identified. The information associated with the virtual space may include at least one of the identifier, the icon, the thumbnail, or the name of the virtual space service provided by the second server 810, but is not limited thereto.

In operation 1513, in an embodiment, the electronic device 400 may transmit the generated application to the first external electronic device 710.

In operation 1515, in an embodiment, the first external electronic device 710 may execute the application received from the electronic device 400.

In operation 1517, in an embodiment, the first external electronic device 710 may select access to the second server 810 corresponding to information associated with the virtual space where a customer service may be used based on executing the application.

In operation 1519, in an embodiment, the first external electronic device 710 may transmit a request for an application for the selected second server 810 to the electronic device 400. The electronic device 400 may generate an application for the second server 810 requested by the first external electronic device 710 based on the request.

In operation 1521, in an embodiment, the electronic device 400 may transmit the generated application to the first external electronic device 710.

In operation 1523, in an embodiment, the first external electronic device 710 may execute the application received from the electronic device 400.

In operation 1525, in an embodiment, the first external electronic device 710 may access the second server 810 based on executing the application received from the electronic device 400. The first external electronic device 710 may display the execution screen associated with the specific position in the virtual space provided by the second server 810 based on accessing the second server 810. For example, while maintaining access to the second server 810, the first external electronic device 710 may display an execution screen associated with the customer service provided by the customer service server 1510.

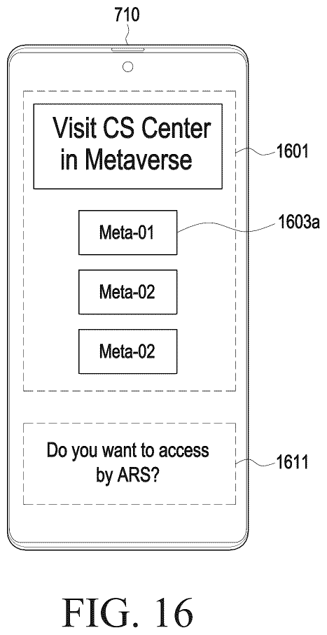

FIG. 16 is a view illustrating an example in which an electronic device (e.g., the electronic device 101 of FIG. 1, the first external electronic device 710 of FIG. 7, or the second external electronic device 720 of FIG. 7) displays an execution screen of an application according to an embodiment of the disclosure.

In an embodiment, the customer service server (e.g., the customer service server 1510 of FIG. 15) may be a server that provides customer service via one or more metaverse servers (e.g., the second server 810 of FIG. 15). The electronic device may display a virtual space screen provided by the customer service server 1510 based on accessing any one of the one or more metaverse servers.

Referring to FIG. 16, in an embodiment, a first external electronic device 710 may display a window 1601 related to access to a virtual environment providing a customer service based on executing the application received from an application server (e.g., the server 108 of FIG. 1 or the electronic device 400 of FIG. 4). The window 1601 related to the access to the virtual environment may include objects respectively corresponding to one or more metaverse servers. In an embodiment, the first external electronic device 710 may further display a window 1611 for a call-based customer service. The first external electronic device 710 may display an execution screen associated with the call application based on a user input to at least a partial area of the window 1611. The user input to the window 1611 may be a touch event to the display module of the first external electronic device 710, but is not limited thereto. The first external electronic device 710 may select a server corresponding to object 1603a among one or more metaverse servers providing the customer service based on the user input to any one object 1603a among the objects included in the window 1601. The first external electronic device 710 may display an execution screen associated with a specific position in the virtual space based on accessing the selected server.

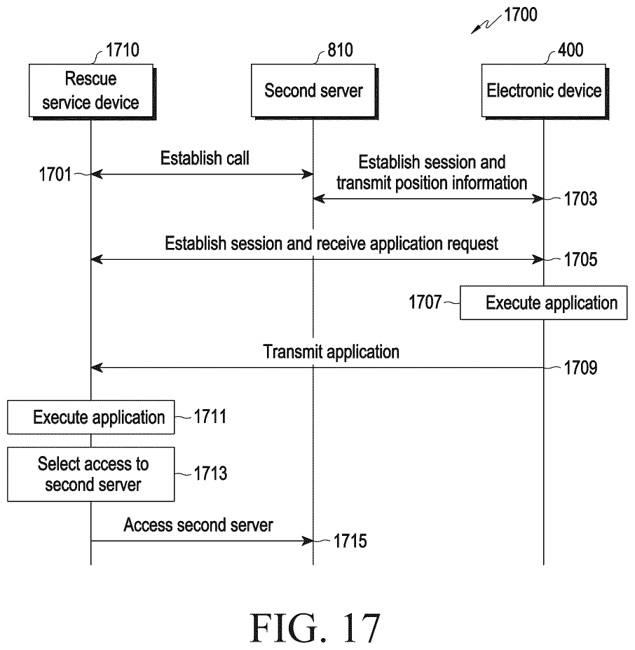

FIG. 17 is a flowchart illustrating an operation in which an electronic device (e.g., the server 108 of FIG. 1 or the electronic device 400 of FIG. 4) generates an application according to an embodiment of the disclosure.

Referring to FIG. 17, according to an embodiment, flowchart 1700 illustrates that, in operation 1701, a rescue service device 1710 and a second server 810 may establish a call. In an embodiment, the rescue service device 1710 may be a server operated by an institution that provides a rescue service. In an embodiment, the rescue service device 1710 may be an electronic device carried by a person in charge of the rescue. In an embodiment, the second server 810 may establish an emergency call with the rescue service device 1710 based on detecting a criminal act in a virtual space provided by the second server 810. For example, the second server 810 may establish an emergency call with the rescue service device 1710 based on receiving a rescue request from a user terminal (e.g., the first external electronic device 710 of FIG. 7 or the second external electronic device 720).

In operation 1703, in an embodiment, an electronic device 400 may establish a session with the second server 810 and receive information associated with a position where a rescue activity is required from the second server 810. For example, information associated with the position where the rescue activity is required may include address information associated with a position in a virtual space provided by the second server 810.

In operation 1705, in an embodiment, the electronic device 400 may establish a session with the rescue service device 1710 and receive a request for an application from the rescue service device 1710.

In operation 1707, in an embodiment, the electronic device 400 may generate an application based on information associated with the position obtained from the second server 810.

In operation 1709, in an embodiment, the electronic device 400 may transmit the generated application to the rescue service device 1710.

In operation 1711, according to an embodiment, the rescue service device 1710 may execute the application received from the electronic device 400.

In operation 1713, in an embodiment, the rescue service device 1710 may select access to the second server 810 based on executing the application.

In operation 1715, in an embodiment, the rescue service device 1710 may perform a rescue for the user of the user terminal in the virtual space based on accessing the address of the position where the rescue activity is required in the virtual space managed by the second server 810. For example, the rescue service device 1710 may request user information associated with the criminal act occurring in the virtual space from the second server 810.

An electronic device (e.g., at least one of the server 108 of FIG. 1 or the electronic device 400 of FIG. 4) may comprise a communication module (e.g., the communication module 410), memory (e.g., the memory 420 of FIG. 4) storing instructions, and at least one processor (e.g., the at least one processor 430 of FIG. 4) operatively connected to the communication module 410 and the memory 420. The instructions may, when executed by the at least one processor 430, cause the electronic device to receive an identifier and log-in information about at least one external electronic device 101 from the at least one external electronic device 101 via the communication module 410. The instructions may, when executed by the at least one processor 430, cause the electronic device to obtain a virtual space list including information associated with at least one virtual space and a position list including information associated with at least one position in the at least one virtual space, based on the identifier and log-in information. The instructions may, when executed by the at least one processor 430, cause the electronic device to generate an application including the virtual space list and the position list. The instructions may, when executed by the at least one processor 430, cause the electronic device to transmit the generated application to the at least one external electronic device 101 via the communication module 410.

According to an embodiment, the instructions may, when executed by the at least one processor 430, cause the electronic device to establish a session for transmitting/receiving data with the at least one external electronic device. The instructions may, when executed by the at least one processor 430, cause the electronic device to receive a request for the application from the at least one external electronic device via the established session.

According to an embodiment, the at least one external electronic device may include a first external electronic device and a second external electronic device establishing a call therebetween. The instructions may, when executed by the at least one processor 430, cause the electronic device to receive a request for the application from the first external electronic device and the second external electronic device via the communication module 410 while the call established between the first external electronic device and the second external electronic device is maintained.

According to an embodiment, the instructions may, when executed by the at least one processor 430, cause the electronic device to transmit a request for at least one of subscription information or log-in information about the at least one external electronic device to a first server via the communication module 410. The instructions may, when executed by the at least one processor 430, cause the electronic device to receive at least one of the subscription information or the log-in information obtained by the first server based on the request from the first server via the communication module 410.

According to an embodiment, the subscription information may include information about whether the at least one external electronic device subscribes to at least one second server. The instructions may, when executed by the at least one processor 430, cause the electronic device to obtain the virtual space list based on the subscription information.

According to an embodiment, the instructions may, when executed by the at least one processor 430, cause the electronic device to transmit a request for the position list to at least one second server corresponding to information associated with at least one virtual space included in the virtual space list via the communication module 410. The instructions may, when executed by the at least one processor 430, cause the electronic device to receive the position list obtained by the at least one second server based on the request from the at least one second server via the communication module 410.

An electronic device (e.g., at least one of the electronic device 101 of FIG. 1, the first external electronic device 710 of FIG. 7, or the second external electronic device 720) may comprise memory (e.g., the memory 130 of FIG. 1) storing instructions, a communication module (e.g., the communication module 190 of FIG. 1), a display module (e.g., the display module 160 of FIG. 1), and at least one processor 120 operatively connected to the memory 130, the communication module 190, and the display module 160. The instructions may, when executed by the at least one processor 120, cause the electronic device to establish a call with an external electronic device via the communication module 190. The instructions may, when executed by the at least one processor 120, cause the electronic device to connect communication with the external electronic device by executing an application received from a first server. The instructions may, when executed by the at least one processor 120, cause the electronic device to select a second server 810 corresponding to information associated with at least one virtual space among one or more virtual spaces included in a virtual space list based on executing the application. The instructions may, when executed by the at least one processor 120, cause the electronic device to transmit selection information of the second server 810 to the external electronic device via the communication module 190.

According to an embodiment, the instructions may, when executed by the at least one processor 120, cause the electronic device to transmit a request for an application to the first server via the communication module 190. The instructions may, when executed by the at least one processor 120, cause the electronic device to receive an application generated by the first server from the first server via the communication module 190.

The instructions may, when executed by the at least one processor 120, cause the electronic device to receive position selection information generated based on selecting identification information about any one of one or more positions included in a position list by the external electronic device from the external electronic device via the communication module 190. The instructions may, when executed by the at least one processor 120, cause the electronic device to change an execution screen of the application based on the received position selection information.

According to an embodiment, the instructions may, when executed by the at least one processor 120, cause the electronic device to select access to the second server 810 corresponding to the information associated with the at least one virtual space among the one or more virtual spaces included in the virtual space list. The instructions may, when executed by the at least one processor 120, cause the electronic device to transmit a request for an application regarding access to the virtual space to the first server. The instructions may, when executed by the at least one processor 120, cause the electronic device to receive the application regarding the access to the virtual space from the first server. The instructions may, when executed by the at least one processor 120, cause the electronic device to access a virtual space selected to be accessed based on executing the received application regarding the access to the virtual space.

According to an embodiment of the disclosure, a method for operating an electronic device may comprise receiving identification information about at least one external electronic device from the at least one external electronic device via a communication module 410. The method may comprise obtaining a virtual space list including information associated with at least one virtual space and a position list including information associated with at least one position in the at least one virtual space, based on the identification information. The method may comprise generating an application including the virtual space list and the position list. The method may comprise transmitting the generated application to the at least one external electronic device via the communication module 410.

According to an embodiment, the method may comprise establishing a session for transmitting/receiving data with the at least one external electronic device. The method may further comprise receiving a request for the application from the at least one external electronic device via the established session.

According to an embodiment, the at least one external electronic device may include a first external electronic device and a second external electronic device establishing a call therebetween. The method may further comprise receiving a request for the application from the first external electronic device and the second external electronic device via the communication module 410 while the call established between the first external electronic device and the second external electronic device is maintained.

According to an embodiment, the method may comprise transmitting a request for at least one of subscription information or log-in information about the at least one external electronic device to a first server via the communication module 410. The method may further comprise receiving at least one of the subscription information or the log-in information obtained by the first server based on the request from the first server via the communication module 410.

According to an embodiment, the subscription information may include information about whether the at least one external electronic device subscribes to at least one second server. The method may further comprise obtaining the virtual space list based on the subscription information.

According to an embodiment, the method may comprise transmitting a request for the position list to at least one second server corresponding to information associated with at least one virtual space included in the virtual space list via the communication module 410. The method may further comprise receiving the position list obtained by the at least one second server based on the request from the at least one second server via the communication module 410.

According to an embodiment of the disclosure, a method for operating an electronic device may comprise establishing a call with an external electronic device via a communication module 190. The method may comprise connecting communication with the external electronic device) by executing an application received from a first server. The method may comprise selecting a second server 810 corresponding to information associated with at least one virtual space among one or more virtual spaces included in a virtual space list based on executing the application. The method may comprise transmitting selection information of the second server 810 to the external electronic device via the communication module 190.

According to an embodiment, the method may comprise transmitting a request for an application to the first server via the communication module 190. The method may further comprise receiving an application generated by the first server from the first server via the communication module 190.

According to an embodiment, the method may comprise receiving position selection information generated based on selecting identification information about any one of one or more positions included in a position list by the external electronic device from the external electronic device via the communication module 190. The method may further comprise changing an execution screen of the application based on the received position selection information.

According to an embodiment, the method may comprise selecting access to the second server 810 corresponding to the information associated with the at least one virtual space among the one or more virtual spaces included in the virtual space list. The method may comprise transmitting a request for an application regarding access to the virtual space to the first server. The method may comprise receiving the application regarding the access to the virtual space from the first server. The method may further comprise accessing a virtual space selected to be accessed based on executing the received application regarding the access to the virtual space.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140 of FIG. 1) including one or more instructions that are stored in a storage medium (e.g., internal memory 136 or external memory 138 of FIG. 1) that is readable by a machine (e.g., the electronic device 101 of FIG. 1). For example, a processor (e.g., the processor 120 of FIG. 1) of the machine (e.g., the electronic device 101 of FIG. 1) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Further, the structure of the data used in embodiments of the disclosure may be recorded in a computer-readable recording medium via various means. The computer-readable recording medium includes a storage medium, such as a magnetic storage medium (e.g., a read only memory (ROM), a floppy disc, or a hard disc) or an optical reading medium (e.g., a CD-ROM or a digital versatile disc (DVD)).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory, comprising one or more storage media, storing instructions; and
one or more processors communicatively coupled to the communication circuitry and the memory,
wherein the instructions, when executed by the one or more processors individually or collectively, cause the electronic device to:
receive, via the communication circuitry from at least one external electronic device, an identifier and log-in information about the at least one external electronic device,
based on the identifier and the log-in information, obtain a virtual space list and a position list, the virtual space list including information associated with at least one virtual space, the position list including information associated with at least one position in the at least one virtual space,
generate an application including the virtual space list and the position list, and
transmit, via the communication circuitry to the at least one external electronic device, the application.

2. The electronic device of claim 1, wherein the instructions, when executed by the one or more processors individually or collectively, further cause the electronic device to:
establish a session for transmitting/receiving data with the at least one external electronic device, and
receive, via the session from the at least one external electronic device, a request for the application.

3. The electronic device of claim 1,
wherein the at least one external electronic device includes a first external electronic device and a second external electronic device establishing a call therebetween, and
wherein the instructions, when executed by the one or more processors individually or collectively, further cause the electronic device to:
receive, via the communication circuitry from the first external electronic device and the second external electronic device, a request for the application while the call established between the first external electronic device and the second external electronic device is maintained.

4. The electronic device of claim 1, wherein the instructions, when executed by the one or more processors individually or collectively, further cause the electronic device to:
transmit, via the communication circuitry to a first server, a request for at least one of subscription information or the log-in information about the at least one external electronic device, and
based on the request, receive, via the communication circuitry from the first server, at least one of the subscription information or the log-in information obtained by the first server.

5. The electronic device of claim 4,
wherein the subscription information includes information about whether the at least one external electronic device subscribes to at least one second server, and
wherein the instructions, when executed by the one or more processors individually or collectively, further cause the electronic device to:
obtain the virtual space list based on the subscription information.

6. The electronic device of claim 1, wherein the instructions, when executed by the one or more processors individually or collectively, further cause the electronic device to:
transmit, via the communication circuitry to at least one second server corresponding to information associated with at least one virtual space included in the virtual space list, a request for the position list, and
based on the request, receive, via the communication circuitry from the at least one second server, the position list obtained by the at least one second server.

7. An electronic device comprising:
memory, comprising one or more storage media, storing instructions;
communication circuitry;
a display; and
one or more processors communicatively coupled to the memory, the communication circuitry, and the display,
wherein the instructions, when executed by the one or more processors individually or collectively, cause the electronic device to:
establish, via the communication circuitry, a call with an external electronic device,
connect communication with the external electronic device by executing an application received from a first server,
based on executing the application, select a second server corresponding to information associated with at least one virtual space among one or more virtual spaces included in a virtual space list, and
transmit, via the communication circuitry to the external electronic device, selection information of the second server.

8. The electronic device of claim 7, wherein the instructions, when executed by the one or more processors individually or collectively, further cause the electronic device to:
transmit, via the communication circuitry to the first server, a request for an application; and
receive, via the communication circuitry from the first server, an application generated by the first server.

9. The electronic device of claim 7, wherein the instructions, when executed by the one or more processors individually or collectively, cause the electronic device to:
receive, via the communication circuitry from the external electronic device, position selection information generated based on selecting identification information about any one of one or more positions included in a position list by the external electronic device, and
change an execution screen of the application based on the position selection information.

10. The electronic device of claim 7, wherein the instructions, when executed by the one or more processors individually or collectively, cause the electronic device to:
select an access to the second server corresponding to the information associated with the at least one virtual space among the one or more virtual spaces included in the virtual space list,
transmit, via the communication circuitry to the first server, a request for an application regarding an access to the virtual space,
receive, via the communication circuitry from the first server, the application regarding the access to the virtual space, and
access a virtual space selected to be accessed based on executing the application regarding the access to the virtual space.

11. A method performed by an electronic device, the method comprising:
receiving, from at least one external electronic device, identification information about the at least one external electronic device;
based on the identification information, obtaining a virtual space list and a position list, the virtual space list including information associated with at least one virtual space, the position list including information associated with at least one position in the at least one virtual space;
generating an application including the virtual space list and the position list; and
transmitting, to the at least one external electronic device, the application.

12. The method of claim 11, further comprising:
establishing a session for transmitting/receiving data with the at least one external electronic device; and
receiving, from the at least one external electronic device via the session, a request for the application.

13. The method of claim 11,
wherein the at least one external electronic device includes a first external electronic device and a second external electronic device establishing a call therebetween, and
wherein the method further comprises:
receiving, from the first external electronic device and the second external electronic device, a request for the application while the call established between the first external electronic device and the second external electronic device is maintained.

14. The method of claim 11, further comprising:
transmitting, to a first server, a request for at least one of subscription information or log-in information about the at least one external electronic device; and
based on the request, receiving, from the first server, at least one of the subscription information or the log-in information obtained by the first server.

15. One or more non-transitory computer-readable storage media storing one or more computer programs including computer-executable instructions that, when executed by one or more processors of an electronic device individually or collectively, cause the electronic device to perform operations, the operations comprising:
receiving, from at least one external electronic device, identification information about the at least one external electronic device;
based on the identification information, obtaining a virtual space list and a position list, the virtual space list including information associated with at least one virtual space and the position list including information associated with at least one position in the at least one virtual space;
generating an application including the virtual space list and the position list; and
transmitting, to the at least one external electronic device, the application.

16. The one or more non-transitory computer-readable storage media of claim 15, the operations further comprising:
establishing a session for transmitting/receiving data with the at least one external electronic device; and
receiving, from the at least one external electronic device via the session, a request for the application.

17. The one or more non-transitory computer-readable storage media of claim 15,
wherein the at least one external electronic device includes a first external electronic device and a second external electronic device establishing a call therebetween, and
wherein the operations further comprise:
receiving, from the first external electronic device and the second external electronic device, a request for the application while the call established between the first external electronic device and the second external electronic device is maintained.

18. The one or more non-transitory computer-readable storage media of claim 15, the operations further comprising:
transmitting, to a first server, a request for at least one of subscription information or log-in information about the at least one external electronic device; and
based on the request, receiving, from the first server, at least one of the subscription information or the log-in information obtained by the first server.

19. The one or more non-transitory computer-readable storage media of claim 18,
wherein the subscription information includes information about whether the at least one external electronic device subscribes to at least one second server, and
wherein the operations further comprise:
obtaining the virtual space list based on the subscription information.

20. The one or more non-transitory computer-readable storage media of claim 15, the operations further comprising:
transmitting, to at least one second server corresponding to information associated with at least one virtual space included in the virtual space list, a request for the position list, and
based on the request, receiving, from the at least one second server, the position list obtained by the at least one second server.
